(19) United States
(12) Patent Application Publication
(10) Pub. No.: US 2025/0269298 A1
(43) Pub. Date: Aug. 28, 2025

(54) CAPILLARY CONDENSING HEAT EXCHANGER

(71) Applicant: IRPI LLC, Wilsonville, OR (US)

(72) Inventors: Mark Weislogel, Newberg, OR (US); Logan J. Torres, Hillsboro, OR (US); Yongkang Chen, Milwaukie, OR (US)

(21) Appl. No.: 19/065,980

(22) Filed: Feb. 27, 2025

Related U.S. Application Data
(60) Provisional application No. 63/558,994, filed on Feb. 28, 2024.

(51) Int. Cl. B01D 5/00; F28D 21/00

(52) U.S. Cl. CPC B01D 5/0006; F28D 2021/0063

(57) ABSTRACT

Methods and systems are provided for an omnigravity compatible capillary condensing heat exchanger. A capillary condensing heat exchanger includes an inlet at a first end, a gas outlet at a second end, opposite the first end, a liquid outlet at the first end, and a conduit configured to direct flow of an airstream containing one or more of liquid droplets, humid air, or gas with a condensable vapor from the inlet to the gas outlet and direct liquid droplets out of the airstream and out of the liquid outlet, wherein the conduit comprises a chamber with a teardrop profile normal to a first axis, the conduit further having interior walls with cusp-like ribs oriented normal to the first axis, such that a vertex of the teardrop profile is axially aligned with the gas outlet along a second axis, parallel to the first axis.

### CROSS REFERENCE TO RELATED APPLICATION

This application claims priority to U.S. Provisional Application No. 63/558,994, entitled “CAPILLARY CONDENSING HEAT EXCHANGER”, filed on Feb. 28, 2024. The entire contest of the above-listed application are hereby incorporated by reference for all purposes.

### FIELD

The present description relates generally to liquid, gas, and/or solid phase separating devices.

### BACKGROUND/SUMMARY

Numerous challenges are faced by the designers of life support systems for spacecraft because of the persistently unfamiliar and unforgiving low-gravity (low-g) environment. Many low-gravity fluid systems ultimately experience multiphase flow conditions, thereby requiring phase separation and management technology.

Efficient heat transfer and condensation of vapor from high moisture content airstream is a significant challenge in microgravity due to complications associated with condensate collection and the lack of significant gravity to perform the task. Existing microgravity systems rely on wetting conditions and distributed drainage ports to suck condensate from the walls of otherwise typical terrestrial heat exchanger designs. However, coatings of such systems are known to degrade during long duration system operation, and drainage ports are often located in places where liquid is less likely or not likely to accumulate in microgravity conditions.

Prior solutions include active separators and passive methods which possess serious shortcomings of complexity and pressure drop. Active separators involve moving parts, which are disadvantageous due to added potential points of degradation that reduce reliability while increasing mass, power consumption, and noise. Passive methods, including vortex/cyclone generators and capillary devices such as membranes, wicks, and conduits, may also be disadvantageous due to their mass and complexity. Centrifuge based phase separation devices demand complex electro-mechanical system design, constant power, and large mass and volume envelopes. Bubble membrane filters are more energy efficient than centrifuges but suffer from increased pressure losses, pump power increases, and special sensitivity to clogging and biofouling. To date, the challenge resides in providing robust phase separation across a range of flow rates and inlet conditions. Therefore, a low pressure drop liquid-gas phase separation device capable of largely passive liquid droplet and gas bubble separation and collection across a broad range of flow rates and inlet conditions is desired.

Condensing heat exchangers (CHX) are tools that separate air and condensate from an input, such as humid air. CHXs are also useful tools aboard spacecraft, in space, and in environments where conditions are different from those on Earth. When used in low- or zero-gravity environments, conventional CHX designs pose significant engineering challenges because, without the ever-present passive acceleration of gravity, condensing liquid films, droplets, and rivulets may not fall, and degassing, outgassing, and boiling vapors may not rise. While these challenges do not prevent CHXs from operating in space, other less familiar forces are exploited to enable system function. There exist designs of microgravity CHXs, such as a Common Cabin Air Assembly (CCAA) CHX and an Extravehicular Mobility Unit (EMU) CHX, that may be used for heating, ventilation, and air conditioning (HVAC) in low-gravity (e.g., low-g) environments, such as in orbit. For example, the CCAA CHX may be deployed in a space station cabin and the EMU CCHX may be used in EMU space suits during extravehicular activities (EVA).

Described herein are methods and systems for an omnigravity compatible capillary condensing heat exchanger (CCHX) conduit. Omnigravitational functionality of the CCHX conduit is enabled by the features described herein, and allows the CCHX conduit to operate in mid-, partial-, and/or hypergravity. The CCHX conduit comprises an inlet at a first end, a gas outlet at a second end, opposite the first end, a liquid outlet at the second end, and a chamber configured to direct flow of an airstream containing one or more of liquid droplets, humid air, or gas with a condensable vapor from the inlet to the gas outlet and direct liquid droplets out of the airstream and to the liquid outlet, wherein the chamber has a teardrop profile, the chamber further having interior walls with a cusp-like structure oriented at a bias angle with respect to a first plane.

The CCHX conduit employs capillary geometry to aid in collection of condensate in heat exchanger conduits without reliance on wetting coatings, such that bulk liquid accumulates in a manner that allows steady state condensate capture and continuous withdrawal. The CCHX conduit exploits combined effects of wetting, surface tension, and system geometry to achieve robust CCHX that is less reliant on wetting conditions than conventional designs, does not use hydrophilic coatings, does not have operational dependence on materials choice, performs passive condensate-air separation, does not slurp, achieves high-efficiency dropwise condensation, is g-independent, and offers physical barriers to condensate carry-over without sacrificing mass, volume, or performance.

The capillary condensing heat exchanger described herein, which includes relaxation of perfect wetting demands, permits a number of key innovations for low-g systems. Benefits include: high performance dropwise condensation throughout a majority of the channels, natural guidance of condensate to condensate exit ports (e.g., liquid outlets) due to capillary conduit geometry, effective superhydrophilic wetting with three-dimensional (3D) crosstalk across the device due to critically geometrically wetted substrates, passive bubble phase separation, reduced carry-over due to efficient pinning that further increases stability to physical perturbations, decreased time of device drying post-use, and increased options for coating-free material selection and fabrication to address concerns of long-term contamination. The CCHX conduit described herein provides, as a non-exhaustive list, the following design features: low mass, low volume, low power, low noise, no coating, no slurper, low pressure differential, low hold-up, no carry-over, no rotary separation, low-g, partial-g, g-perturbations, form factor, ground testable, dormancy, bio-safe, no blockage, no soft goods, case of integration, minimum parts, low-g demo, low sense/control, comparability, and resists contaminants.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a first perspective view of a condensing heat exchanger (CCHX) conduit;

FIG. 2 shows a second perspective view of the CCHX conduit;

FIG. 3 shows a first end view and a second end view of the CCHX conduit;

FIG. 4 shows a cross-sectioned side view of the CCHX conduit;

FIG. 5 shows a first cross-sectioned view of the CCHX conduit from a first side;

FIG. 6 shows a second cross-sectioned view of the CCHX conduit from a second side, opposite the first side;

FIG. 7 shows a third perspective view and a fourth perspective view of the CCHX conduit;

FIG. 8 shows a first perspective view of a vertical stack CCHX that includes the CCHX conduit;

FIG. 9 shows a second perspective view of the vertical stack CCHX;

FIG. 10 shows a side view of the vertical stack CCHX;

FIG. 11 shows a first cross-sectioned side view of the vertical stack CCHX;

FIG. 12 shows the first cross-sectioned side view of the vertical stack CCHX in further detail;

FIG. 13 shows a cross-sectioned view of the vertical stack CCHX from a second end;

FIG. 14 shows a second cross-sectioned side view and a third cross-sectioned side view of the vertical stack CCHX;

FIG. 15 shows a fourth cross-sectioned side view of the vertical stack CCHX;

FIG. 16 shows a first perspective view of a horizontal stack CCHX that includes the CCHX conduit;

FIG. 17 shows a second perspective view of the horizontal stack CCHX;

FIG. 18 shows a first cross-sectioned side view of the horizontal stack CCHX;

FIG. 19 shows a first cross-sectioned perspective view of the horizontal stack CCHX;

FIG. 20 shows a second cross-sectioned perspective view of the horizontal stack CCHX;

FIG. 21 shows a second cross-sectioned side view and a third cross-sectioned side view of the horizontal stack CCHX;

FIG. 22 shows a first perspective view of a hollow cylinder CCHX that includes the CCHX conduit;

FIG. 23 shows a second perspective view of the hollow cylinder CCHX;

FIG. 24 shows a first cross-sectioned side view of the hollow cylinder CCHX;

FIG. 25 shows a first cross-sectioned perspective view of the hollow cylinder CCHX;

FIG. 26 shows a second cross-sectioned perspective view of the hollow cylinder CCHX;

FIG. 27 shows a second cross-sectioned side view of the hollow cylinder CCHX;

FIG. 28 shows a third cross-sectioned perspective view of the hollow cylinder CCHX;

FIG. 29 shows a first perspective view of a cusped center cylinder (CCC) CCHX that includes the CCHX conduit;

FIG. 30 shows a first end view of the CCC CCHX;

FIG. 31 shows a second perspective view of the CCC CCHX;

FIG. 32 shows a first cross-sectioned side view of the CCC CCHX;

FIG. 33 shows a first cross-sectioned perspective view of the CCC CCHX;

FIG. 34 shows a second cross-sectioned perspective view of the CCC CCHX;

FIG. 35 shows a second cross-sectioned side view of the CCC CCHX;

FIG. 36 shows a third cross-sectioned perspective view of the CCC CCHX;

FIG. 37 shows a first perspective view of a center channel cylinder (CHC) CCHX that includes the CCHX conduit;

FIG. 38 shows a shows a first end view of the CHC CCHX;

FIG. 39 shows a cross-sectioned view of the CHC CCHX from a first end;

FIG. 40 shows a second perspective view of the CHC CCHX;

FIG. 41 shows a second end view of the CHC CCHX;

FIG. 42 shows a cross-sectioned view of the CHC CCHX from a second end, opposite the first end;

FIG. 43 shows a first cross-sectioned side view of the CHC CCHX;

FIG. 44 shows a first cross-sectioned perspective view of the CHC CCHX;

FIG. 45 shows a second cross-sectioned perspective view of the CHC CCHX;

FIG. 46 shows a second cross-sectioned side view of the CHC CCHX;

FIG. 47 shows a first perspective view of a circumferential cooling cylinder (CFC) CCHX that includes the CCHX conduit;

FIG. 48 shows a shows a first end view of the CFC CCHX;

FIG. 49 shows a second perspective view of the CFC CCHX;

FIG. 50 shows a second end view of the CFC CCHX;

FIG. 51 shows a first cross-sectioned side view of the CFC CCHX;

FIG. 52 shows a first cross-sectioned perspective view of the CFC CCHX;

FIG. 53 shows a second cross-sectioned perspective view of the CFC CCHX;

FIG. 54 shows a third cross-sectioned perspective view of the CFC CCHX;

FIG. 55 shows a second cross-sectioned side view of the CFC CCHX;

FIG. 56 shows a first perspective view of a herringbone CCHX that includes the CCHX conduit;

FIG. 57 shows a second perspective view of the herringbone CCHX;

FIG. 58 shows a first cross-sectioned side view of the herringbone CCHX;

FIG. 59 shows a first cross-sectioned perspective view of the herringbone CCHX;

FIG. 60 shows a second cross-sectioned perspective view of the herringbone CCHX;

FIG. 61 shows a third cross-sectioned perspective view of the herringbone CCHX;

FIG. 62 shows a fourth cross-sectioned perspective view of the herringbone CCHX;

FIG. 63 shows a fifth cross-sectioned perspective view of the herringbone CCHX;

FIG. 64 shows a sixth cross-sectioned perspective view of the herringbone CCHX;

FIG. 65 shows an example condensing heat assembly including the herringbone CCHX;

FIG. 66 shows a flow chart of a method for extracting liquid from a humid airstream using a CCHX conduit; and

FIG. 67 shows views of an example CCHX that includes the CCHX conduit positioned in a helical or spiral configuration.

### DETAILED DESCRIPTION

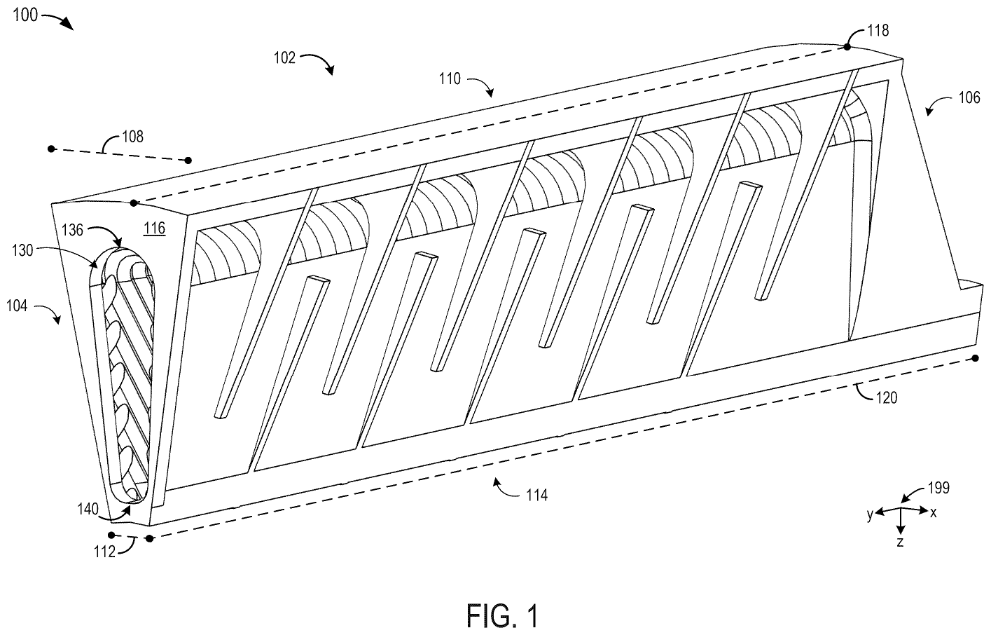

The following description relates to systems and methods for a CCHX conduit that condenses a humid airstream and/or a condensable gas stream, and passively preferentially locates poorly partially wetting liquid for recirculation without application of contaminable surface coatings or treatments. The CCHX conduit described herein does not employ a wetting coating and may be constructed of a wide variety of materials. A method for condensing liquid droplets from the humid airstream using the CCHX conduit comprises directing the humid airstream into the conduit of the CCHX conduit via the inlet, condensing liquid from the humid airstream into droplets, directing droplets into the cusp-like ribs of the conduit, wicking droplets towards the vertex of the teardrop profile, directing droplets out of the CCHX conduit via the liquid outlet and directing gas of the humid airstream out of the CCHX conduit via the gas outlet. The CCHX conduit may be included in a variety of applications for separating and collecting elements of a multiphase fluid (e.g., including a gas and a liquid). A plurality of examples of a CCHX are described herein. FIGS. 1-64 and 67 are shown approximately to scale.

Condensing systems are used in nearly all life support systems aboard spacecraft to create a closed loop water cycle. In general, terrestrial condensers present cold surfaces to saturated vapor streams (e.g., humid air), which leads to condensate build-up on partially wetted substrates in the form of large wall-bound droplets or films. As the droplets grow and the film thickens, gravity acts to drive the excess liquid downwards into collections chambers for recirculation and further processing. Poorly wetting condensate and condensate surface wall materials produce dropwise condensation conditions, which may result in up to ten times higher heat transfer rates than perfectly wetting film condensation conditions due to increased exposure of direct vapor-wall surface areas. For spacecraft, it is desirable to achieve high rates of dropwise condensation heat transfer despite a near-weightless state of the microgravity environment. In such environments, terrestrial geometries may not function properly.

Generally, in the absence of gravity, dropwise condensation proceeds with continued growth and coalescence of wall bound droplets which eventually leads to large sized droplets occluding the conduit air passageway, increasing flow resistance temporarily as the droplets are potentially being swept/driven along the wall of the airstream into a downstream conduit. The CCHX conduit described herein replaces the role of gravity by exploiting passive capillary forces to wick wall-bound drops of liquid from poorly wetted regions to more favorably wetted regions in a manner that maintains a predominantly dropwise condensation process. When geometry of the CCHX conduit is cooled, the CCHX conduit yields condensate droplets that increase in size to the point where they are coalesced and wicked toward a central passive capillary drain structure. A net effect of the CCHX conduit geometry is to replace the role of gravity with that of liquid surface tension, wetting, and conduit shape.

As described herein, efficient low-g dropwise condensation is achievable by employing a single or parallel array of capillary geometric elements to a wide variety of poorly wetting surfaces. Relaxation of perfect wetting demands permits a number of key innovations for a low-g system. The CCHX conduit described herein provides a passive geometric solution for wall-bound droplet and thin film condensate drainage in a microgravity environment. A spacecraft thermal system employing the CCHX conduit may be capable of earthlike reliability in that liquid droplets and films drain passively due to passive capillary forces that replace the role of gravity. The CCHX may be employed in numerous life-support systems aboard spacecraft, including central crew cabin heating, ventilation, and air conditioning (HVAC), extravehicular activity (EVA) extravehicular mobility unit (EMU), cold plates, and specialty condensing heat exchangers (e.g., plant and animal habitats, process equipment, and so on). These and other such systems may benefit from increased reliability of liquid gas separation provided by the CCHX conduit described herein.

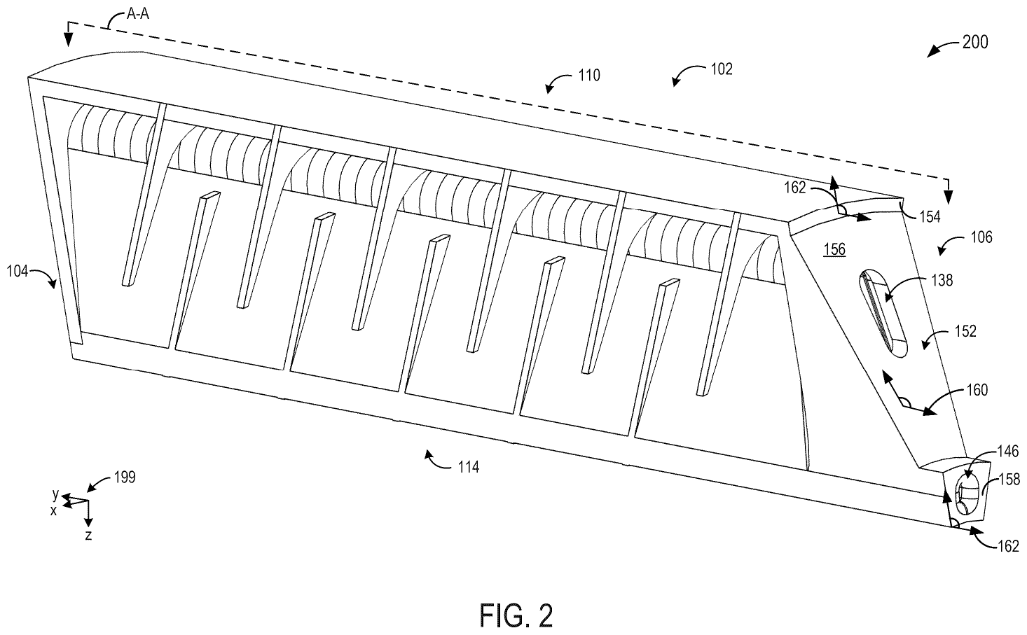

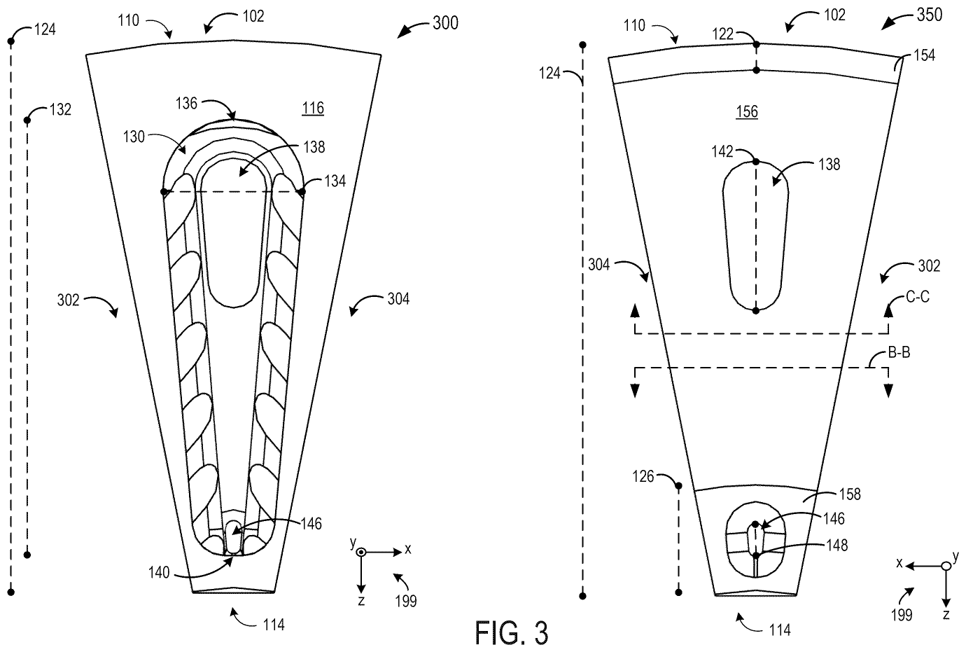

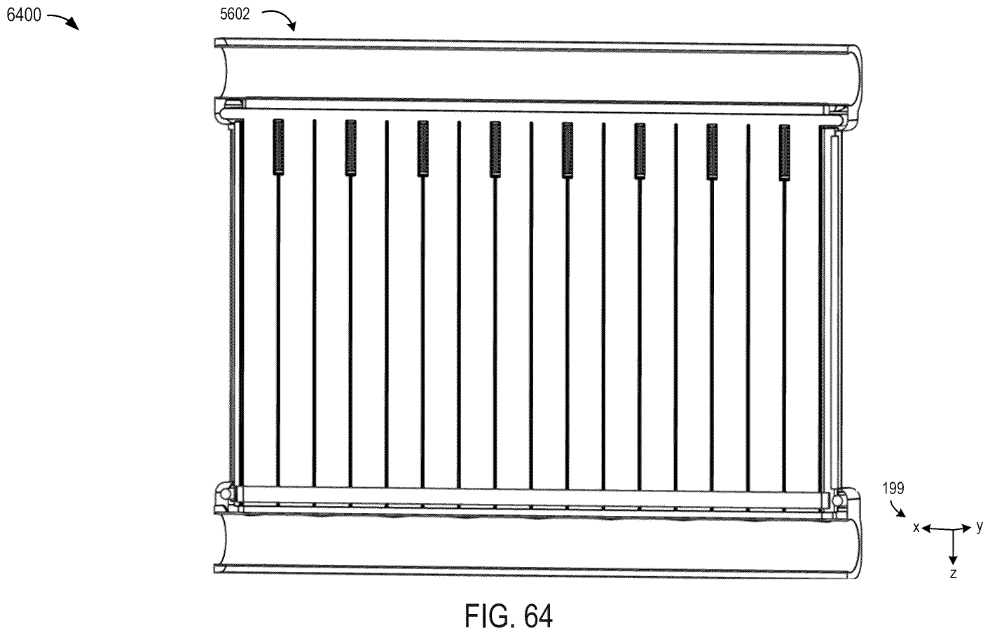

FIG. 1 shows a first perspective view 100 of a capillary condensing heat exchanger (CCHX) conduit 102. FIG. 2 shows a second perspective view 200 of the CCHX conduit 102. FIG. 3 shows a first end view 300 of the CCHX conduit 102 from a first end 104, and a second end view 350 of the CCHX conduit 102 from a second end 106, opposite the first end 104. FIGS. 1-3 are described simultaneously herein. An axis system 199 is provided in FIGS. 1-64 for reference. The y-axis may be a vertical axis, the x-axis may be a lateral axis, and the z-axis may be a longitudinal axis, in one example. However, the axes may have other orientations, in other examples. The CCHX conduit 102 is an omnigravity device, thus the axis system 199 is provided as a spatially orienting axis, and may or may not correspond to a gravitational direction.

The CCHX conduit 102 may have a wedge shape, where a first width 108 at a first side 110 of the CCHX conduit 102 is greater than a second width 112 at a second side 114 of the CCHX conduit 102. The first width 108 and/or the second width 112 may be curved. At the first end 104 of the CCHX conduit 102, the first width 108 and the second width 112 may be coupled by a planar face 116. The CCHX conduit 102 may have a first conduit length 118 along the first side 110 of the CCHX conduit 102 and a second conduit length 120 along the second side 114 of the CCHX conduit 102. The first conduit length 118 may be less than the second conduit length 120. The first conduit length 118 may extend along a first portion 122 of a conduit height 124 of the CCHX conduit 102. The second conduit length 120 may extend along a second portion 126 of the conduit height 124. At the second end 106 of the CCHX conduit 102, the first width 108 and the second width 112 may be coupled by a face 152. The face 152 includes a first segment 154, a second segment 156, and a third segment 158, all of which are continuous with each other. The first segment 154 and the third segment 158 may be connected by the second segment 156, which is configured as a planar angled face that is positioned at a first angle 160, relative to the x-z plane of the axis system 199. The first segment 154 and the third segment 158 may also be planar, and may be positioned a second angle 162 that may be different from the first angle 160 of the second segment 156. In some examples, the second angle 162 of the first segment 154 and the third segment 158 may be different from each other.

The conduit 102 comprises an inlet 130 at the first end 104, as shown in FIG. 1. The inlet 130 may be a cutout in the planar face 116. The inlet 130 may have a teardrop profile having an inlet height 132. The inlet height 132 may be less than the conduit height 124. The first width 108 of the CCHX conduit 102 at the first side 110 may be greater than a maximum width 134 of the inlet 130 (e.g., near an apex 136 of the inlet 130). The second width 112 of the CCHX conduit 102 at the second side 114 may be greater than a minimum width of the inlet 130 at a vertex 140 of the inlet 130.

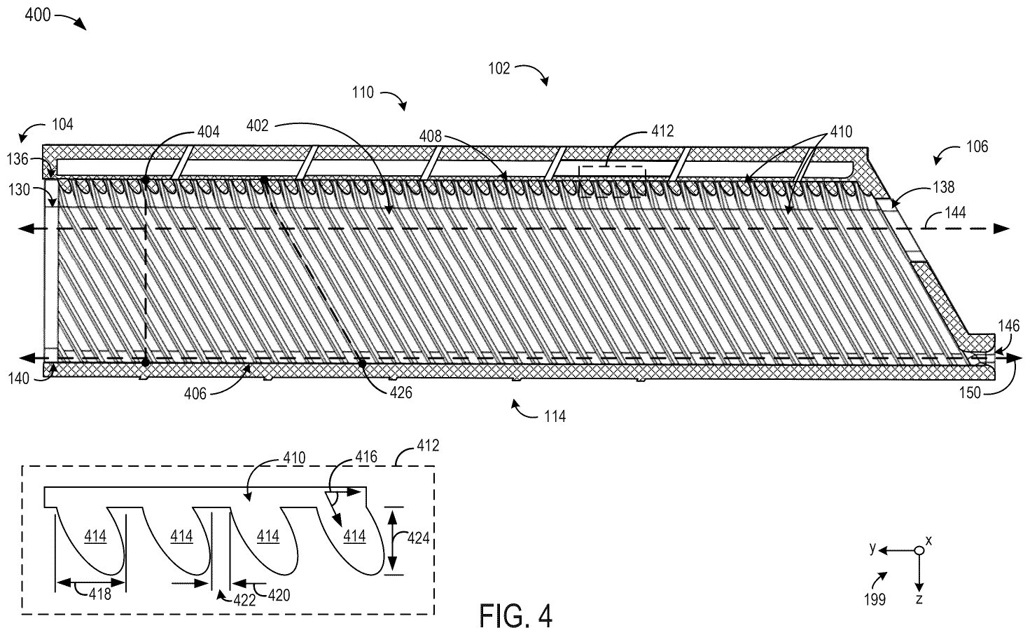

The conduit 102 includes a gas outlet 138 at the second end 106, as shown in FIG. 2. In some examples, the gas outlet 138 may be positioned opposite the inlet 130 at a different axial position, such as at a 90° angle from the inlet 130. The gas outlet 138 may be a cutout in the second segment 156. The gas outlet 138 may have an oval profile, in some examples. In other examples, the gas outlet 138 may have a differently shaped profile. The gas outlet 138 has a gas outlet height 142 that is less than the inlet height 132 of the inlet 130. The gas outlet 138 is positioned near the first side 110 of the CCHX conduit 102 and is axially aligned with the inlet 130 along a first axis 144, as shown in FIG. 4.

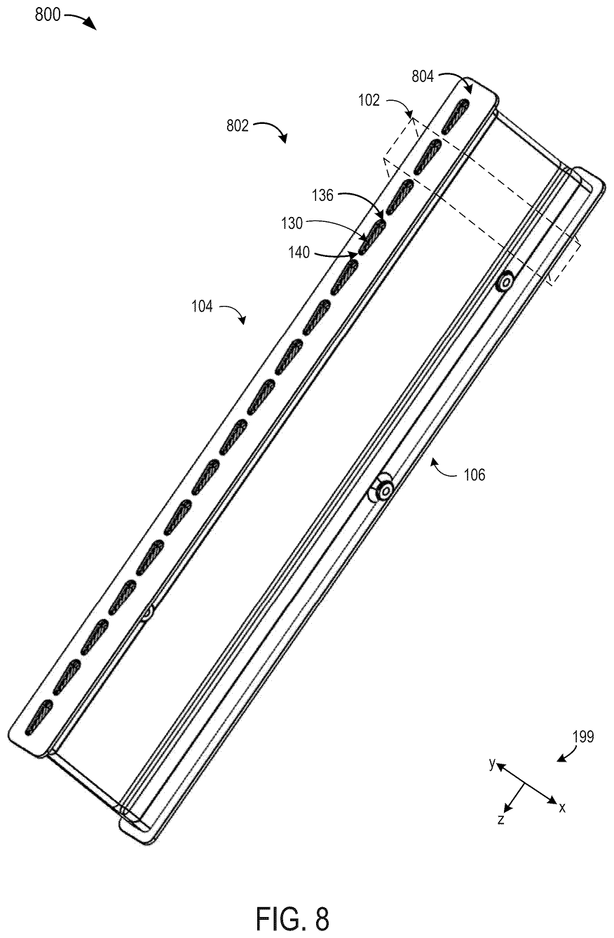

The conduit 102 includes a liquid outlet 146 at the second end 106, as shown in FIG. 2. In other configurations of the CCHX conduit 102, the liquid outlet 146 may be positioned at various locations within and/or along the CCHX conduit 102. For example, the liquid outlet 146 may be located preferentially based on geometry of a system and/or device in which the CCHX conduit 102 is implemented. A gas/vapor mixture (e.g., an airstream) enters the CCHX conduit 102 at the inlet 130, vapor is condensed and channeled by features of the CCHX conduit 102 described below to collect and drain condensate from the CCHX conduit 102 via the liquid outlet 146. The draining location of the condensate may vary. Various example implementations of the CCHX conduit 102 are described herein with respect to FIGS. 8-65 and 67. The liquid outlet 146 may be a cutout in the second portion 126 of the conduit height 124 at the second end 106 of the CCHX conduit 102. The liquid outlet 146 may have a circular profile in some examples, or a differently shaped profile in other examples. The liquid outlet 146 has a liquid outlet height 148 that is less than the inlet height 132 of the inlet 130. The liquid outlet height 148 may be equal to or less than the gas outlet height 142 of the gas outlet 138. The liquid outlet 146 is positioned near the second side 114 of the CCHX conduit 102 and is axially aligned with the inlet 130 along a second axis 150, as shown in FIG. 4.

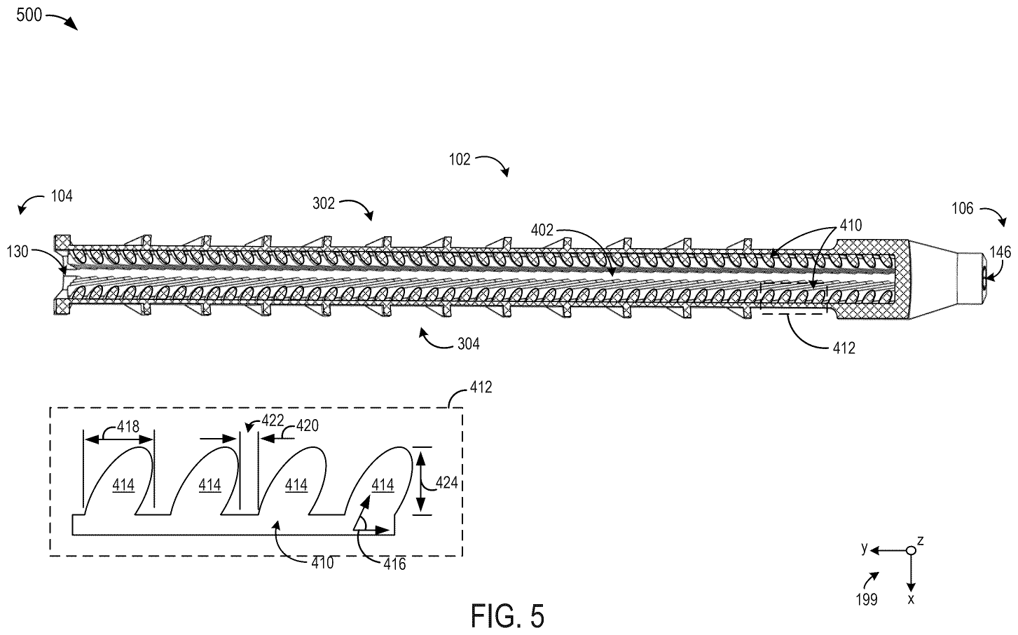

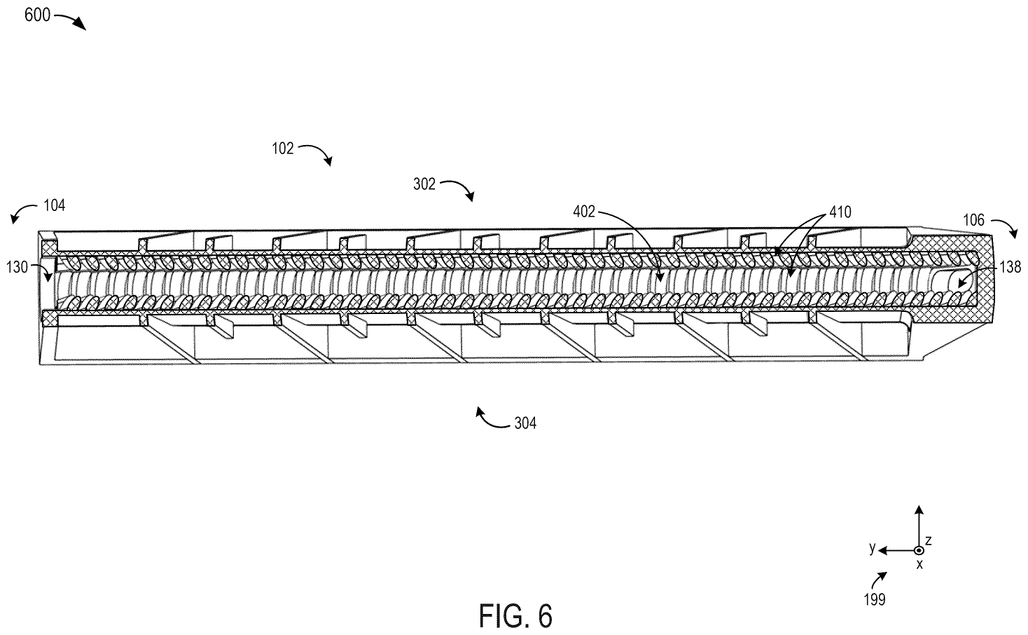

FIG. 4 shows a cross-sectioned side view 400 of the CCHX conduit 102 taken along an axis A-A of FIG. 2. FIG. 5 shows a first cross-sectioned view 500 of the CCHX conduit 102 taken along an axis B-B of FIG. 3. FIG. 6 shows a second cross-sectioned view 600 of the CCHX conduit 102 taken along an axis C-C of FIG. 3. FIGS. 4-6 are described simultaneously herein.

The conduit 102 includes a chamber 402 configured to direct flow of an airstream containing one or more of liquid droplets, humid air, or gas with a condensable vapor from the inlet 130 to the gas outlet 138, and direct liquid droplets out of the airstream and to the liquid outlet 146. The chamber 402 may have a teardrop profile. When the inlet 130 has a teardrop profile, dimensions of the teardrop profile of the chamber 402 may be the same as dimensions of the inlet 130. For example, the chamber 402 may have a chamber height 404 that is equal to the inlet height 132 of the inlet 130. A vertex 406 of the teardrop profile of the chamber 402 is axially aligned with the vertex 140 of the inlet 130, and with the liquid outlet 146, along the second axis 150. An apex 408 of the teardrop profile of the chamber 402 is axially aligned with the apex 136 of the inlet 130, and with the gas outlet 138, along the first axis 144.

The chamber 402 further comprises interior walls having a cusp-like structure 410, which is shown in further detail in a box 412. The cusp-like structure 410 includes elliptical ribs 414 that may be oriented at a bias angle 416 with respect to a first plane. For example, the first plane may be the plane in which the planar face 116 at the first end 104 is arranged. With respect to the axis system 199, the first plane may be the x-z plane. The bias angle 416 may be between −90° and 90° in various CCHX conduit configurations. For example, the bias angle 416 may be positive, zero, or negative.

The cusp-like structure 410 comprises a repeating pattern of elliptical ribs 414 defined by a width 418 of each elliptical rib 414, a gap width 420 of a gap 422 between elliptical ribs 414, and a height 424 of each elliptical rib 414 that extends towards a center of the chamber 402. The height 424 may be, for example, less than 1 millimeter (mm). The gap width 420 may be, for example, less than 0.3 mm. The repeating pattern can be iteratively generated, producing nearly cusp-like channels. The first end view 300 of FIG. 3 shows the cusp-like structure 410 in further detail. Each elliptical rib 414 of the cusp-like structure 410 extends continuously around a third side 302, the first side 110, and a fourth side 304 of interior walls of the chamber 402. For example, each elliptical rib 414 extends along the chamber height 404 on the third side 302 of the chamber 402, along a chamber width at the apex 408 of the chamber 402, and along the chamber height 404 on the fourth side 304 of the chamber 402. The chamber width may be equal to the width of the inlet 130 (e.g., the chamber width at the apex 408 of the chamber 402 is equal to an inlet width at the apex 136 of the inlet 130). Each elliptical rib extends the height 424 towards a center of the chamber 402.

When applied en masse as surface structure (e.g., on the interior walls of the chamber 402), the cusp-like structure 410 may allow for spontaneous in-filling along the structure (e.g., in the gaps between the elliptical ribs), forming liquid filaments that decrease an effective macro-scale contact angle of the chamber 402 to values that achieve desirable macro-scale capillary flows. The cusp-like structure 410 spontaneously wets along a cusp length 426, where the cusp length 426 is a length of the gap 422 between two elliptical ribs 414 from the first side 110 to the second side 114 of the chamber 402. The cusp length 426 may be greater than the chamber height 404 of the chamber 402 due to the bias angle 416 of the cusp-like structure 410. For example, a poorly wetting water drop with a contact angle θ of approximately 70° plus or minus 20°. When the cusps are fully saturated (e.g., gaps 422 between elliptical ribs 414 contain liquid that fills an available volume of each gap 422), wetting of the substrate (e.g., the cusp-like structure 410) at the macro-scale may be nearly perfect, may have an effective contact angle (θ_{eff}) of less than 20°. Applying the cusp-like structure 410 to the teardrop profile of the chamber 402 provides capillary wicking paths from the elliptical ribs 414, along the gaps 422, to the vertex 406 of the chamber 402. The vertex 406 of the chamber 402 is also critically geometrically wetted by the liquid due to the effective reduced contact angle θ_{eff} of approximately 20°<90°−α. The vertex 406 of the chamber 402 may have an acute half-angle α of 10°, which may be drained conscientiously. When condensation occurs within the chamber 402, condensate droplets grow on the crests of the elliptical ribs 414. For example, condensate droplets may increase up to approximately 500 micrometers (μm) before they merge with condensate droplets of either of the two neighboring elliptical ribs 414. Condensate droplets are wicked towards the vertex 406 of the chamber 402, thus achieving a mixed drop-wise and film-wise condensing surface. The elliptical ribs 414 of the cusp-like structure 410 may be favorably aligned to feed condensate to the vertex 406 of the chamber 402 where the bulk condensate may be drained from the liquid outlet 146 without the aid of gravity.

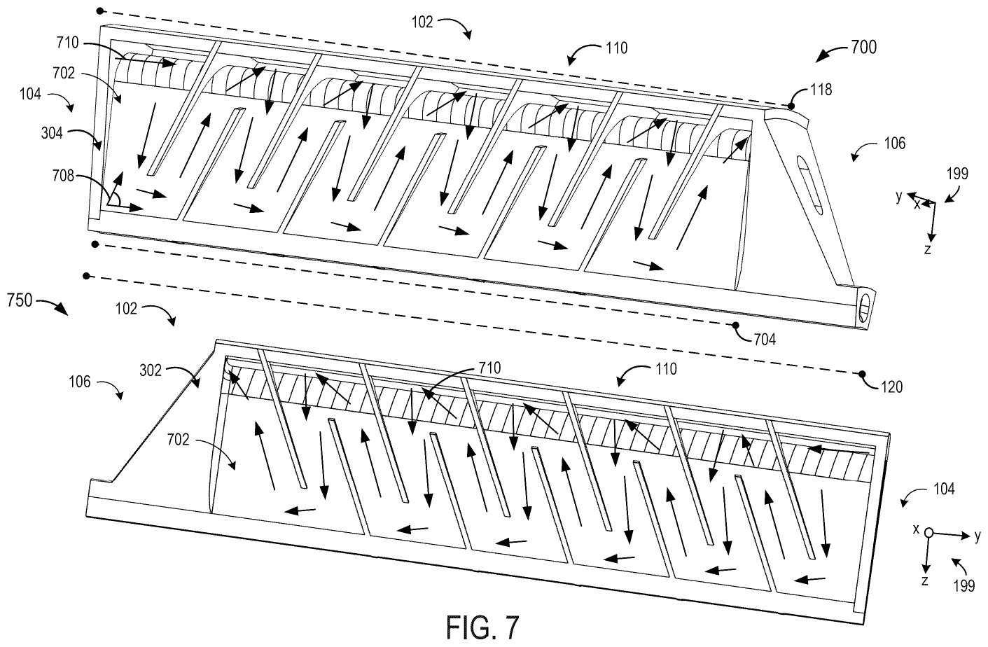

FIG. 7 shows a third perspective view 700 and a fourth perspective view 750 of the CCHX conduit 102, and illustrates a coolant channel 702 of the CCHX conduit 102. The coolant channel 702 is positioned external to and fluidly isolated from the chamber 402. The coolant channel 702 may extend parallel to the chamber 402 along each of the third side 302 and the fourth side 304 of the CCHX conduit 102, and may be fluidly continuous among the third side 302, the first side 110 (e.g., parallel to the apex 408 of the chamber 402) and the fourth side 304. The coolant channel 702 may be fluidly isolated from the chamber 402 of the CCHX conduit 102. When the CCHX conduit 102 is implemented in a system, such as a CCHX, the coolant channel 702 may be part of a coolant system through which a coolant is flowed to control a temperature of the conduit. The coolant channel 702 may extend a coolant channel length 704, which may be less than both the first conduit length 118 and the second conduit length 120. The coolant channel 702 may have a serpentine pattern that extends from the first end 104 to the second end 106 of the CCHX conduit 102, such that a path length of the coolant channel 702 (e.g., from the first end 104, around each bend of the serpentine pattern, to the second end 106) is greater than a coolant channel length 704 of the coolant channel 702. The serpentine pattern of the coolant channel 702 may be positioned at a second bias angle 708 with respect to the first plane (e.g., the x-z plane with respect to the axis system 199). The second bias angle 708 of the serpentine pattern may be the same angle and oriented in the same direction as the bias angle 416 of the cusp-like structure 410 of the chamber 402. In another example, the second bias angle 708 of the serpentine pattern may be opposite that of the bias angle 416 of the cusp-like structure 410 of the chamber 402. In further examples, the serpentine pattern may be oriented normal to the first plane (e.g., no bias angle). Described another way, the coolant channel 702 may be a single coolant channel with a serpentine pattern that spans both the third side 302 and the fourth side 304 of the CCHX conduit 102, via the first side 110 of the CCHX conduit 102, in such a way that the coolant channel 702 is fluidly isolated from the chamber 402 and is positioned on the third side 302 and the fourth side 304 of the chamber 402 to cool the chamber 402, where coolant flows among the first side 110, the third side 302, and the fourth side 304. The coolant channel 702 extends from the first side 110 of the CCHX conduit 102, superior to the apex 408 of the teardrop profile of the chamber 402, and to the second side 114 of the CCHX conduit 102.

For example, coolant may enter the coolant channel 702 at the first end 104. An example coolant flow path is shown by a set of arrows 710. The coolant channel 702 of the CCHX conduit 102 may be fluidly coupled to a coolant system and/or coolant source, examples of which are described with respect to FIGS. 8-65 and 67. Coolant flows through the serpentine pattern of the coolant channel 702 from the third side 302, across the first side 110, to the fourth side 304, and back. Coolant may exit the coolant channel 702 at the second end 106.

A humid airstream (e.g., an airstream containing liquid droplets) enters the conduit of the CCHX conduit 102 via the inlet (e.g., at humid air in). Geometry of the conduit (e.g., cusp-like structure and the teardrop profile) directs condensation of liquid droplets out of the humid airstream. As wall-bound dropwise condensate droplets nucleate and grow in size, liquid droplets span and enter a cusp region of the cusp-like ribs of interior walls of the conduit. Liquid is wicked along the cusp region in both directions (e.g., in a downward direction generally parallel with the z-axis along walls of the cusp region towards the vertex), eventually making capillary connection with the vertex 406 of the chamber 402. Surfaces of the elliptical ribs 414 serve as directionally critically geometrically wetted substrate. The cusp-like structure 410 may serve as a wetting substrate for a wide range of liquids. In this way, dropwise condensation may be achieved, such that liquid droplets are removed from the humid airstream, in low-g conditions. Employment of the cusp-like ribs and cusp regions thereof establishes an ever-decreasing interior corner angle that promotes such wetting. For example, critical geometric wetting of the interior corner angle (e.g., the vertex) may occur when an advancing contact angle (θ) of the vertex is less than π/2−α, where α is a half-angle of the vertex. Liquid droplets that are condensed out of the humid airstream by the cusp-like ribs of the conduit are directed out of the CCHX conduit 102 via the liquid outlet (e.g., “condensate out”), and gases of the airstream (e.g., collectively, the airstream) are directed out of the CCHX conduit 102 via the gas outlet (e.g., “dry air out”).

Thus, coatings that may enhance wetting of a surface (e.g., the conduit surface) may not be used in the CCHX conduit 102 to separate liquid and gases of a humid airstream. This may expand a design space of the CCHX conduit 102 to include a wide variety of materials, not just highly wetting materials. Coatings may degrade more quickly due to flaking, chipping, cracking, contaminating, and in general losing wetting characteristics while contaminating downstream systems. The CCHX conduit 102 may therefore be formed of any variety of materials, including metals, polymers, and/or other materials.

In this way, the CCHX conduit 102 provides solutions for a capillary controlled condensing heat exchanger (CCHX). A CCHX having the CCHX conduit 102 described herein with respect to FIGS. 1-7 provide a broad range of benefits and advancements in CCHX performance by superposing capillary fluidics solutions on conventional CCHX features. The cusp substrate construction provided by the cusp-like structure 410 enables critical geometric wetting of the gaps (also ‘cusp grooves’) leading to near superhydrophilicity despite a wide variety of poorly wetting conditions. ‘Perfect’ wetting is thus achieved without a coating for most aqueous solutions including highly contaminated water on highly contaminated substrates. Surface treatments, as are used in conventional CCHX designs, are not necessary to achieve the same or increased fluidic separation. Interior surfaces of the channels are constructed of cusp surfaces that are printed using additive manufacturing (e.g., 3D-printing), or machined directly into a substrate material (e.g., into the interior walls of the chamber 402). The CCHX conduit 102 further provides increased efficiency of heat transfer as aided by dropwise condensation. Stable dropwise condensation may be achieved over approximately 80% of the cusp-like structure 410, which may be up to 10 times as efficient in heat transfer over film condensation compared to conventional CCHX designs. A reduction in mass and volume of the CCHX conduit compared to conventional CCHX designs is thus achieved without sacrifices to performance. Film condensation is also achieved, where condensing drops grow to a size at which point they wet into the gaps and are driven by passive geometrically-created capillary pressure gradients to the condensate filaments connecting directly to the liquid outlet(s). The liquid outlet and the gas outlet provide continuous flow drain ports with no slurping. The tapered section of the chamber 402 (e.g., provided by the teardrop shape of the chamber 402) draws liquid towards the vertex 406 by the critical geometric wetting principle. The teardrop cross-section of the chamber 402 serves as a capillary length scale design alongside substrate roughness (e.g., material forming the chamber 402), cusp width (e.g., elliptical rib width), drain port (e.g., liquid outlet) diameter, channel taper gap, and channel width (e.g., gap width). Tapering of the chamber 402 provides the passive flow mechanism that bathes the liquid outlet in condensate. A pressure and/or liquid level sensor may be positioned at the liquid outlet 146 to trigger withdrawing of liquid from the CCHX conduit 102 with no further demand for downstream phase separation. The CCHX conduit 102 provides three-dimensional (3D) capillary connectivity, which provides a desired distribution of flow. Despite potential for variable, poor, or unknown wettability (e.g., due to contamination), the combination of the elliptical ribs 414 and the interconnected tapered channels (e.g., gaps 422 between the elliptical ribs 414 in the tapered teardrop profile of the chamber 402) provides 3D capillary cross-talk to the degree that condensate may be drained from the CCHX conduit 102 via a natural capillary fluid mechanism that establishes uniform fluid and thermal distribution across the CCHX conduit 102. The CCHX conduit 102 further provides robust continuous pinning edges. In applications where the gas flow rate is higher and inertia is greater (We˜1) a strong pinning edge allows enhanced carry-over mitigation at the expense of increased pressure loss. By combining mechanical energy (e.g., pinning edge geometry) and wetting energy (e.g., contact angle gradient), passive pinning edge effectiveness is increased such that carry-over may be reduced (e.g., by approximately 3 times conventional levels), condensate drain profiles may be simplified (e.g., decrease by approximately 27 times conventional complexity), and increased stability to perturbations (e.g., by approximately 3 times conventional amount). The CCHX conduit 102 has a decreased dryout time compared to conventional CCHX designs due to the efficient drying geometries provided by the chamber 402. The net effect of the cusp-like structure 410 is to spread the condensate evenly across the chamber 402 as a thin film. High surface area-to-volume ratio fluid bodies provide fast and easy evaporation. The CCHX conduit uses passive capillary mechanisms to better control and collect condensate for omnigravitational applications. The CCHX conduit may be implemented in EMU portable life support system (PLSS) applications, though other applications are possible without departing from the scope of the present disclosure.

The CCHX conduit 102 described with respect to FIGS. 1-7 may be implemented in a CCHX device comprising two or more CCHX conduits. A CCHX may include a set of conduits comprised of multiple of the conduit arranged in different configurations. A number of example CCHX configurations are provided herein, though it is to be understood that these are non-limiting examples. As further described herein, a CCHX comprises a set of conduits. One or more of the conduits of the CCHX are the conduit 102 of FIGS. 1-7. Thus, each conduit of the set of conduits comprises an inlet at a first end; a gas outlet at a second end, opposite the first end; a liquid outlet at the second end; and a chamber configured to direct flow of an airstream containing one or more of liquid droplets, humid air, or gas with a condensable vapor from the inlet to the gas outlet and direct liquid droplets out of the airstream and to the liquid outlet, wherein the chamber has a teardrop profile such that a vertex of the teardrop profile is axially aligned with the liquid outlet, the chamber further having interior walls with cusp-like structures oriented at a bias angle with respect to a first plane (e.g., the plane in which the planar face 116 is positioned, the x-z of the axis system 199). In some examples, the gas outlet may be positioned opposite the inlet at a different axial position, such as at a 90° angle from the inlet. The bias angle may be between −90° and 90° in various CCHX conduit configurations. For example, the bias angle may be positive, zero, or negative. The CCHX further comprises a coolant system. The coolant system may include a coolant inlet on a first channel, a coolant outlet on a second channel, and a set of one or more coolant channels that are fluidly coupled to the first channel and the second channel. The set of coolant channels may include one or more of the coolant channel 702 of FIGS. 1-7. The CCHX may include features that direct condensate flow out of the CCHX. For example, the CCHX may include a liquid outlet channel that is coupled to each conduit of the set of conduits via the liquid outlet of the respective conduit.

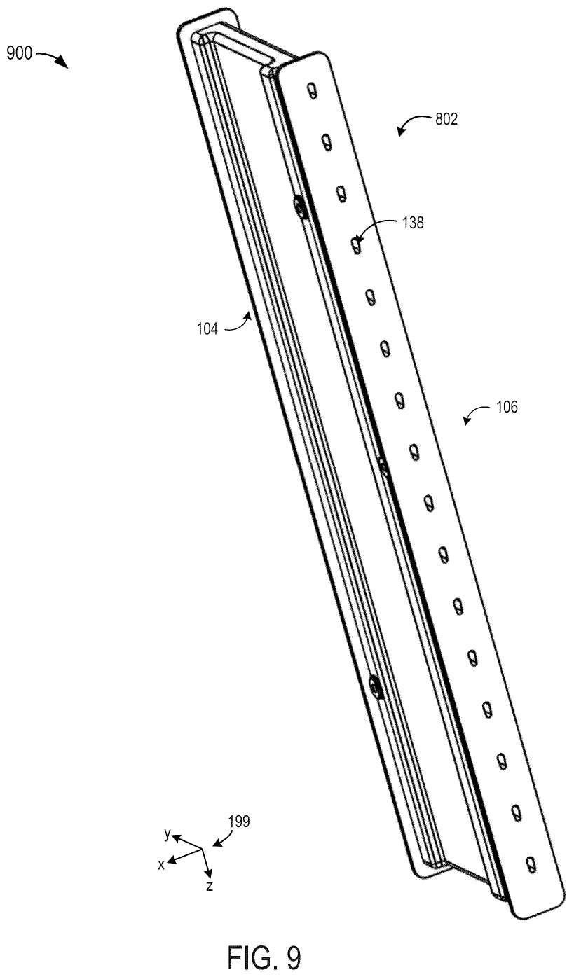

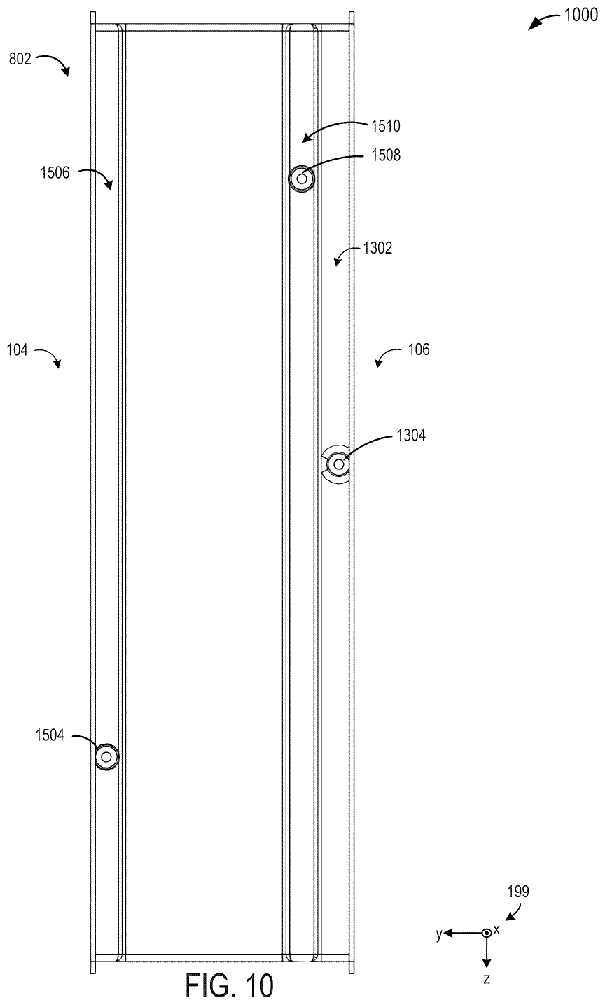

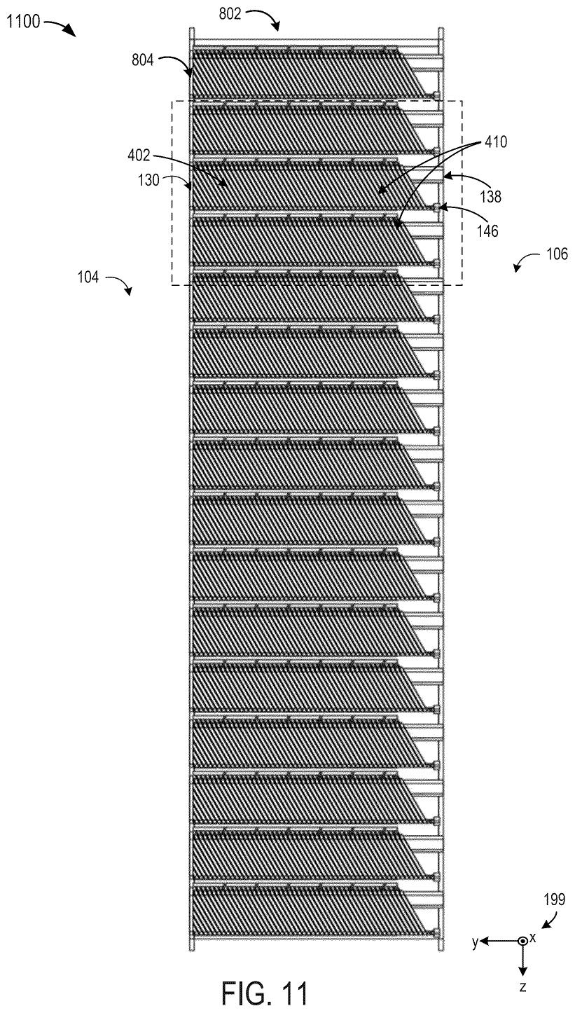

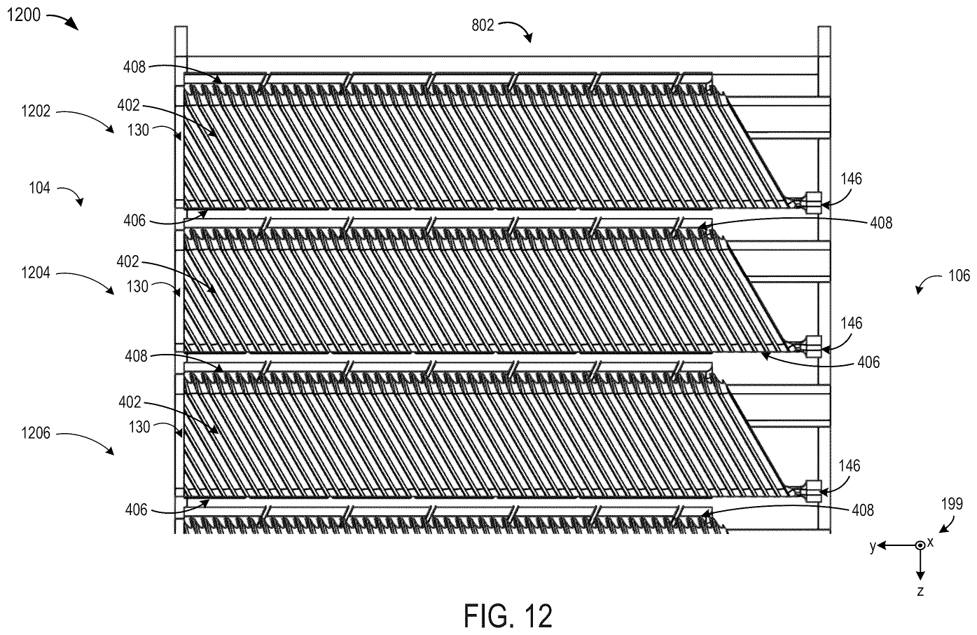

FIGS. 8-15 show a first example of a CCHX including one or more of the CCHX conduit 102 described above. The first example CCHX is also referred to herein as a vertical stack CCHX 802. FIG. 8 shows a first perspective view 800 of the vertical stack CCHX 802, and FIG. 9 shows a second perspective view 900 of the vertical stack CCHX 802. FIG. 10 shows a side view 1000 of the vertical stack CCHX. FIG. 11 shows a first cross-sectioned side view 1100 of the vertical stack CCHX 802, and FIG. 12 shows the first cross-sectioned side view 1100 in further detail 1200. FIGS. 8-12 are described simultaneously herein.

The vertical stack CCHX 802 comprises a set of CCHX conduits 804, where each CCHX conduit of the set of CCHX conduits 804 is stacked vertically with respect to the other CCHX conduits of the set of CCHX conduits 804. Each CCHX conduit of the set of CCHX conduits 804 may include an inlet 130 at a first end 104, a gas outlet 138 and a liquid outlet 146 at a second end 106, and a chamber 402 having a teardrop profile and interior walls with a cusp-like structure 410 oriented at a bias angle with respect to a first plane (e.g., the x-z plane of the axis system 199) that are configured to direct flow of an airstream containing one or more of liquid droplets, humid air, or gas with a condensable vapor from the inlet to the gas outlet 138 and direct liquid droplets out of the airstream and to the liquid outlet 146. For example, one or more of the CCHX conduits of the set of CCHX conduits 804 may be the CCHX conduit 102 of FIGS. 1-7. Elements of the CCHX conduits of the set of CCHX conduits 804 having the same name and numbering conventions as elements of the CCHX conduit 102 of FIGS. 1-7 are to be understood as being the same element, and may not be reintroduced for brevity.

Each CCHX conduit of the set of CCHX conduits 804 is stacked vertically with respect to other CCHX conduits of the set of CCHX conduits 804. Described another way, the vertex 406 of the teardrop profile of the chamber 402 of a CCHX conduit is arranged superior to the apex 408 of the teardrop profile of the chamber 402 of a CCHX conduit positioned immediately below. For example, the vertex 406 of the chamber 402 of a first CCHX conduit 1202 is superior to the apex 408 of a second CCHX conduit 1204, the vertex 406 of the second CCHX conduit 1204 is superior to the apex 408 of a third CCHX conduit 1206, and so on. The inlet 130 of each CCHX conduit of the set of CCHX conduits 804 may be vertically aligned. The gas outlet 138 of each CCHX conduit of the set of CCHX conduits 804 may be vertically aligned. The liquid outlet 146 of each conduit of the set of CCHX conduits 804 may be vertically aligned.

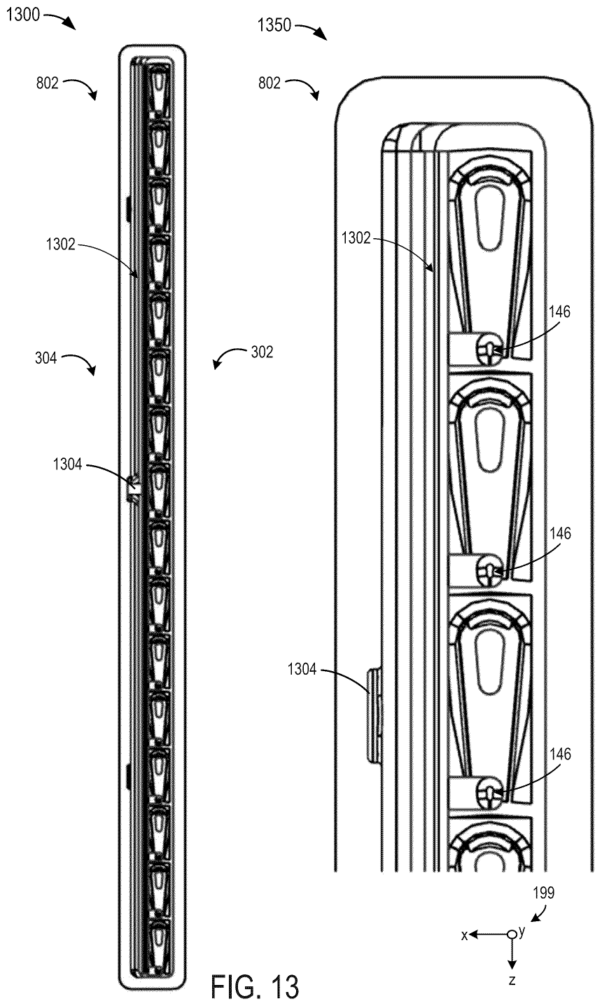

FIG. 13 shows a cross-sectioned view 1300 of the vertical stack CCHX 802 from the second end 106. An enhanced view 1350 shows a portion of the cross-sectioned view 1300 in further detail. Each CCHX conduit of the set of CCHX conduits 804 may be fluidly coupled to a liquid outlet channel 1302 of the vertical stack CCHX 802 via the liquid outlet 146 of the respective CCHX conduit. The liquid outlet channel 1302 may include a liquid outlet port 1304.

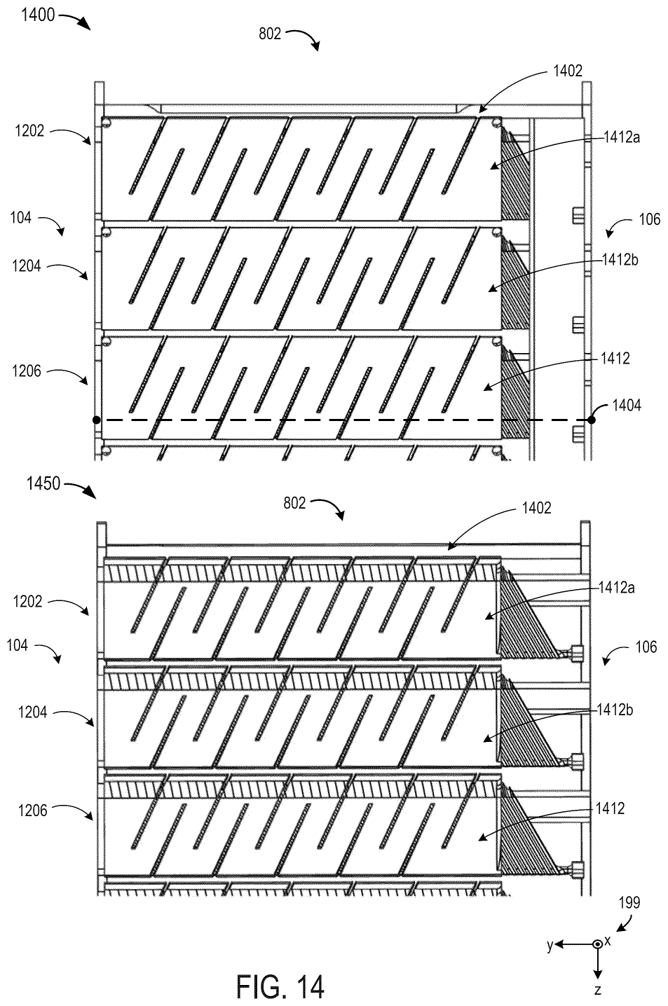

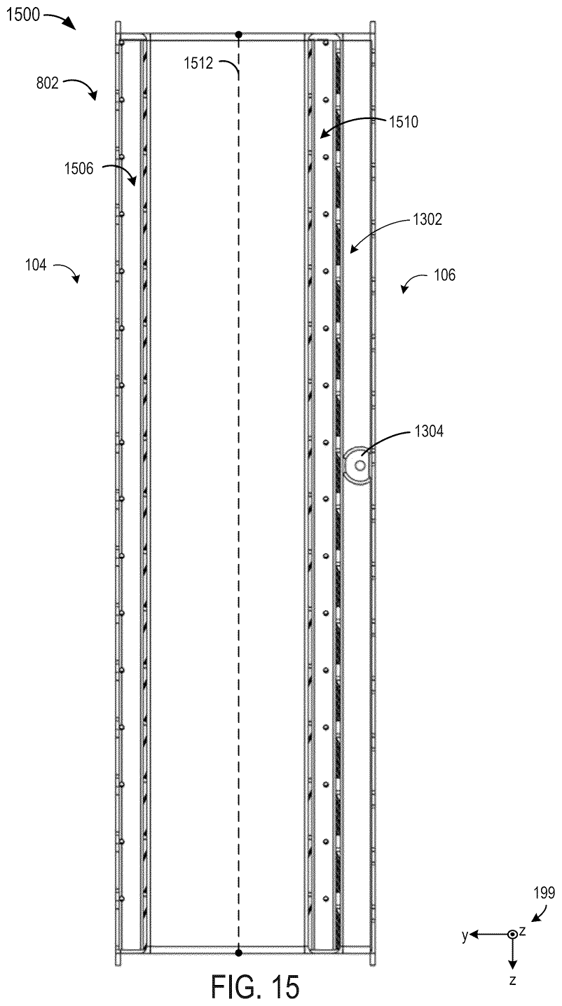

FIG. 14 shows a second cross-sectioned side view 1400 and a third cross-sectioned side view 1450 of the vertical stack CCHX 802. FIG. 15 shows a fourth cross-sectioned side view 1500 of the vertical stack CCHX 802. FIGS. 14 and 15 are described simultaneously herein. The vertical stack CCHX 802 further comprises a coolant system 1402 configured to cool the set of CCHX conduits 804. The coolant system 1402 is positioned external to and fluidly isolated from chambers of the set of CCHX conduits 804. The coolant system 1402 may include a coolant inlet 1504 on a first channel 1506, a coolant outlet 1508 on a second channel 1510 (also see FIG. 10), and a set of coolant channels 1412 that are fluidly coupled to the first channel 1506 and the second channel 1510. The first channel 1506 and the second channel 1510 of the coolant system 1402 of the vertical stack CCHX 802 are positioned parallel to the set of CCHX conduits 804. The first channel 1506 is positioned near the first end 104 of the vertical stack CCHX 802 (e.g., near the inlet 130 of each conduit of the set of CCHX conduits 804). The first channel 1506 extends a height 1512 of the vertical stack CCHX 802. The second channel 1510 is positioned posterior to the first channel 1506, with respect to the axis system 199, near the second end 106 of the vertical stack CCHX 802. The second channel 1510 is parallel to the first channel 1506. The second channel 1510 extends the height 1512 of the vertical stack CCHX 802.

Each coolant channel 1412 is positioned with respect to a corresponding CCHX conduit of the set of CCHX conduits 804, as described with respect to FIGS. 1-7. For example, a first coolant channel 1412a of the first CCHX conduit 1202 extends along the third side 302 and the fourth side 304 of the vertical stack CCHX 802 (see FIG. 13) parallel to a vertical stack CCHX length 1404 of the vertical stack CCHX 802. The first coolant channel 1412a further extends parallel to the apex 408 of the first CCHX conduit 1202, where the portion of the first coolant channel 1412a superior to the apex 408 of the chamber 402 fluidly couples the portions of the coolant channel 1412 on the third side 302 and the fourth side 304 of the chamber 402. Each conduit of the set of CCHX conduits 804 may have a similar coolant channel configuration. In addition to cooling a respective conduit (e.g., when coolant is flowed through the coolant channel 1412) a coolant channel may cool a conduit positioned immediately above the respective conduit. For example, a second coolant channel 1412b of the second CCHX conduit 1204 has a portion that extends parallel to the apex 408 of the chamber 402 of the second CCHX conduit 1204 for the vertical stack CCHX length 1404. The portion of the second coolant channel 1412b that extends parallel to the apex 408 may be in close enough proximity to the vertex 406 of the chamber 402 of the first coolant channel 1412a that the second coolant channel 1412b may provide cooling to the first CCHX conduit 1202 in addition to the second CCHX conduit 1204. This may be the case for multiple coolant channels of the vertical stack CCHX 802.

Each coolant channel 1412 of the vertical stack CCHX 802 may be fluidly coupled to the first channel 1506 of the coolant system 1402 at the first end 104, and fluidly coupled to the second channel 1510 of the coolant system 1402 at the second end 106. Coolant may flow into the coolant system 1402 via the coolant inlet 1504, flow from the coolant inlet 1504 through the first channel 1506 of the coolant system 1402 and into each coolant channel of the set of coolant channels 1412. One or more of the coolant channels of the set of coolant channels 1412 may have a serpentine pattern. The serpentine pattern may extend from the third side 302, over the apex 408 of the respective chamber, and to the fourth side 304.

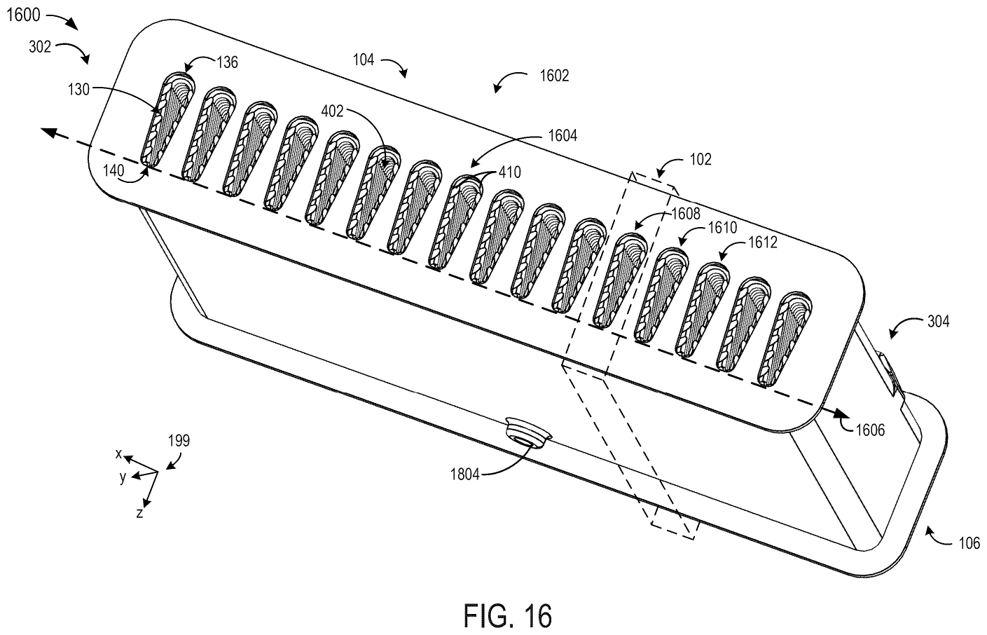

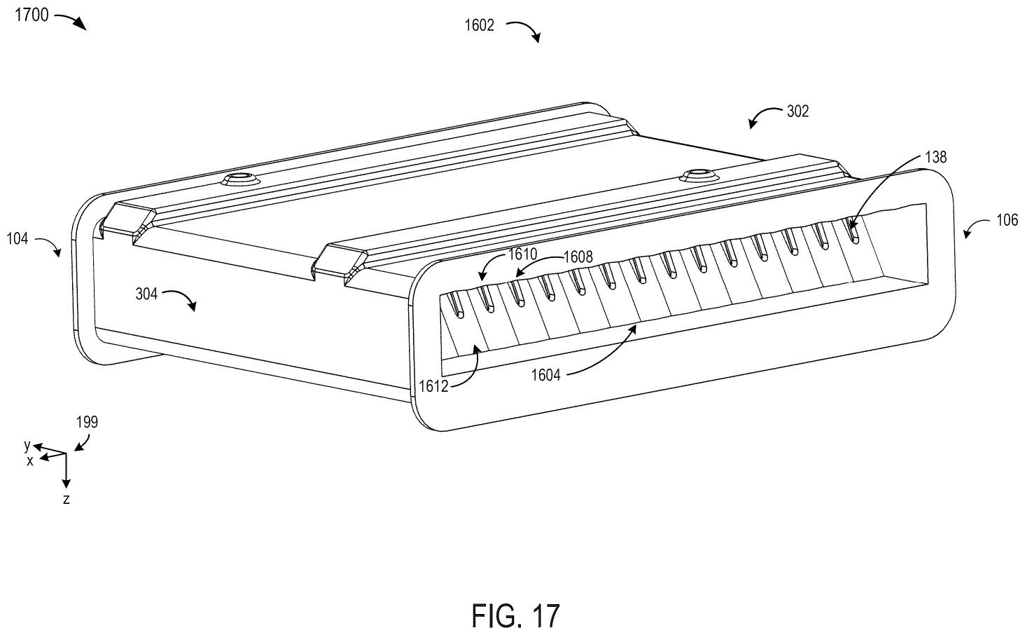

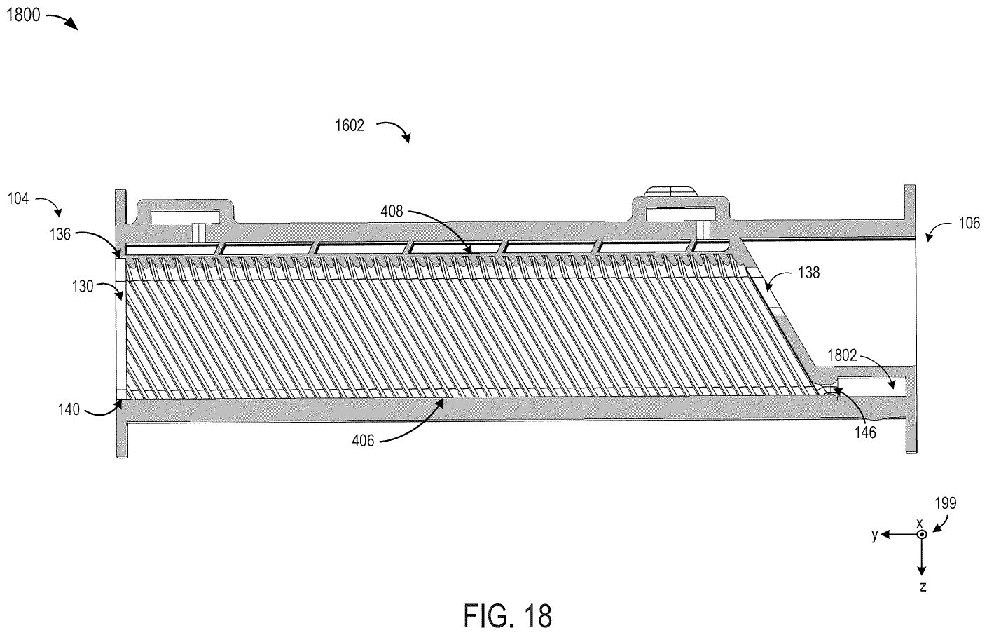

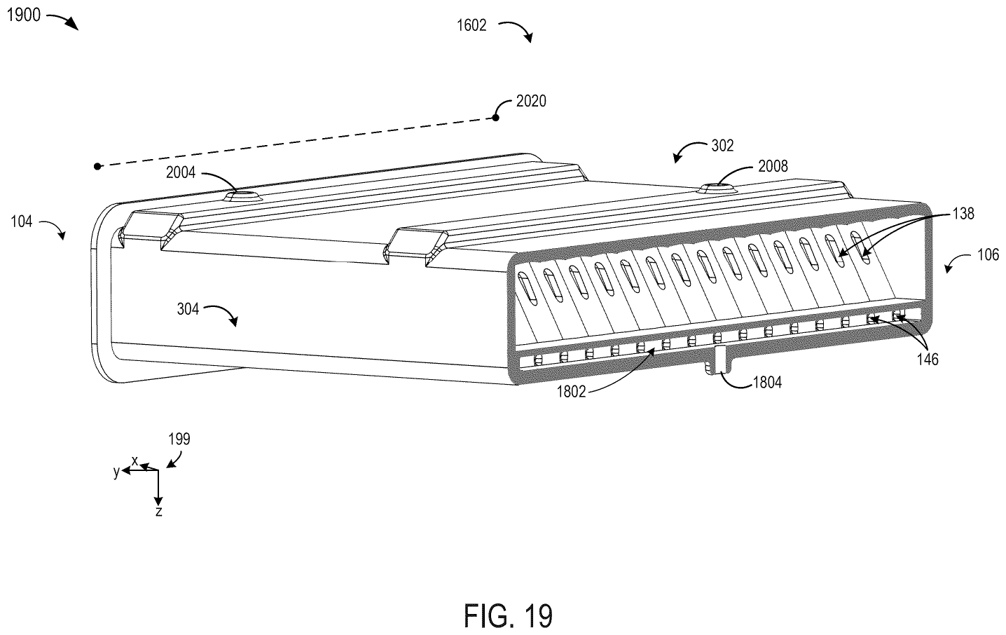

FIGS. 16-21 show a second example of a CCHX including one or more of the CCHX conduit 102 described above. The second example CCHX is also referred to as a horizontal stack CCHX 1602. FIG. 16 shows a first perspective view 1600 of the horizontal stack CCHX 1602, and FIG. 17 shows a second perspective view 1700 of the horizontal stack CCHX 1602. FIG. 18 shows a first cross-sectioned side view 1800 of the horizontal stack CCHX 1602. FIG. 19 shows a first cross-sectioned perspective view 1900 of the horizontal stack CCHX 1602. FIGS. 16-19 are described simultaneously herein.

The horizontal stack CCHX 1602 comprises a set of CCHX conduits 1604, where each CCHX conduit of the set of CCHX conduits 1604 is stacked horizontally with respect to the other CCHX conduits of the set of CCHX conduits 1604. Each CCHX conduit of the set of CCHX conduits 1604 may include an inlet 130 at a first end 104, a gas outlet 138 and a liquid outlet 146 at a second end 106, and a chamber 402 having a teardrop profile and interior walls with a cusp-like structure 410 oriented at a bias angle with respect to a first plane (e.g., the x-z plane with respect to the axis system 199) that are configured to direct flow of an airstream containing one or more of liquid droplets, humid air, or gas with a condensable vapor from the inlet to the gas outlet 138 and direct liquid droplets out of the airstream and to the liquid outlet 146. For example, one or more of the CCHX conduits of the set of CCHX conduits 1604 may be the CCHX conduit 102 of FIGS. 1-7. Elements of the CCHX conduits of the set of CCHX conduits 1604 having the same name and numbering conventions as elements of the CCHX conduit 102 of FIGS. 1-7 are to be understood as being the same element, and may not be reintroduced for brevity.

Each CCHX conduit of the set of CCHX conduits 1604 is stacked horizontally with respect to other CCHX conduits of the set of CCHX conduits 1604. The vertex 140 of each inlet 130 of the set of CCHX conduits 1604 are aligned along a third axis 1606. Similarly, the vertex 406 of the teardrop profile of the chamber 402 of each CCHX conduit are aligned along an axis that is parallel to the third axis 1606 (e.g., parallel to the x-axis). The inlet 130 of each CCHX conduit of the set of CCHX conduits 1604 may be horizontally aligned. For example, the vertex 140 of the inlet 130 of a first CCHX conduit 1608 is to the left of and in line with the vertex 140 of the inlet 130 of a second CCHX conduit 1610, along the third axis 1606. The vertex 140 of the inlet 130 of the second CCHX conduit 1610 is to the left of and in line with the vertex 140 of the inlet 130 of a third CCHX conduit 1612, along the third axis 1606, and so on. The gas outlet 138 of each CCHX conduit of the set of CCHX conduits 1604 may be arranged at the bias angle with respect to the first plane. The liquid outlet 146 of each CCHX conduit of the set of CCHX conduits 1604 may be horizontally aligned.

Each CCHX conduit of the set of CCHX conduits 1604 may be fluidly coupled to a liquid outlet channel 1802 of the horizontal stack CCHX 1602 via the liquid outlet 146 of the respective CCHX conduit. The liquid outlet channel 1802 include a liquid outlet port 1804.

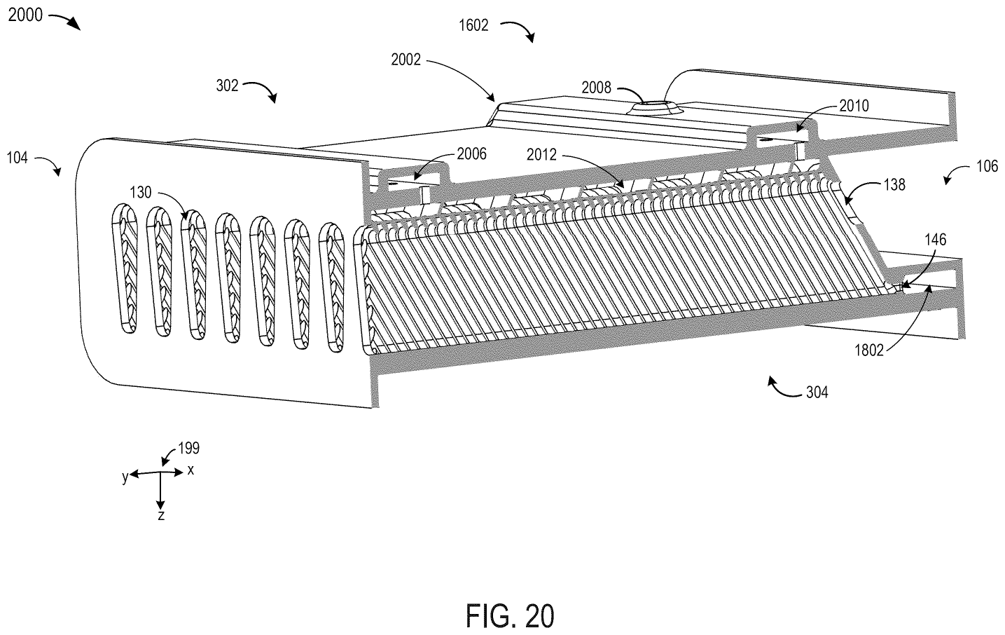

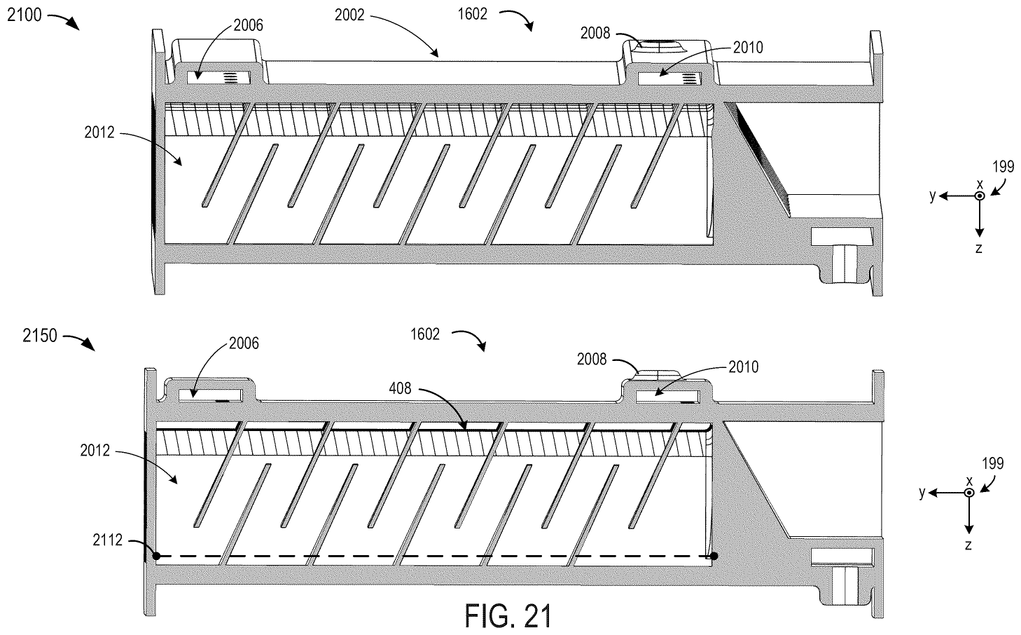

FIG. 20 shows a second cross-sectioned perspective view 2000 of the horizontal stack CCHX 1602. FIG. 21 shows a second cross-sectioned side view 2100 and a third cross-sectioned side view 2150 of the horizontal stack CCHX 1602. FIGS. 20 and 21 are described simultaneously herein. The horizontal stack CCHX 1602 further comprises a coolant system 2002 configured to cool the set of CCHX conduits 1604. The coolant system 2002 is positioned external to and fluidly isolated from chambers of the set of CCHX conduits 1604. The coolant system 2002 may include a coolant inlet 2004 on a first channel 2006 (see FIGS. 17 and 19), a coolant outlet 2008 on a second channel 2010, and a set of coolant channels 2012 that are fluidly coupled to the first channel 2006 and the second channel 2010. The first channel 2006 and the second channel 2010 of the coolant system 2002 of the horizontal stack CCHX 1602 are positioned superior to the set of CCHX conduits 1604. The first channel 2006 is positioned near the first end 104 of the horizontal stack CCHX 1602 (e.g., near the inlet 130 of each conduit of the set of CCHX conduits 1604). The first channel 2006 extends a width 2020 of the horizontal stack CCHX 1602 (see FIG. 19). The second channel 2010 is positioned posterior to the first channel 2006, with respect to the axis system 199, near the second end 106 of the horizontal stack CCHX 1602. The second channel 2010 is parallel to the first channel 2006. The second channel 2010 extends the width 2020 of the horizontal stack CCHX 1602.

Each coolant channel 2012 is positioned with respect to a corresponding CCHX conduit of the set of CCHX conduits 1604, as described with respect to FIGS. 1-7. The coolant channel 2012 may extend a coolant channel length 2112, which may be less than both the first conduit length 118 and the second conduit length 120. For example, a coolant channel 2012 extends along the coolant channel length 2112, parallel to the apex 408 of the chamber 402, where the portion of the coolant channel 2012 superior to the apex 408 of the chamber 402 fluidly couples the portions of the coolant channel 2012 on the third side 302 and the fourth side 304 of the chamber 402. Each CCHX conduit of the set of CCHX conduits 1604 may have a similar coolant channel configuration. In addition to cooling a respective conduit (e.g., when coolant is flowed through the coolant channel), a coolant channel may cool a conduit positioned immediately laterally adjacent (e.g., parallel) to the respective conduit. For example, a second coolant channel of the second CCHX conduit 1610 has a portion on the third side 302 of the chamber 402 of the second CCHX conduit 1610 that is between the second CCHX conduit 1610 and the third CCHX conduit 1612 and that extends along the coolant channel length 2112, and a portion on the fourth side 304 of the chamber 402 of the second CCHX conduit 1610 that is between the second CCHX conduit 1610 and the first CCHX conduit 1608 for the coolant channel length 2112. The second coolant channel 2012 may be in close enough proximity to the first CCHX conduit 1608 and the third CCHX conduit 1612 that the second coolant channel 2012 may provide cooling to the first CCHX conduit 1608 and the third CCHX conduit 1612 in addition to the second CCHX conduit 1610. This may be the case for multiple coolant channels of the horizontal stack CCHX 1602.

Each coolant channel of the set of coolant channels 2012 of the horizontal stack CCHX 1602 may be fluidly coupled to the first channel 2006 of the coolant system 2002 at the first end 104, and fluidly coupled to the second channel 2010 of the coolant system 2002 at the second end 106. Coolant may flow into the coolant system 2002 via the coolant inlet 2004, flow from the coolant inlet 2004 through the first channel 2006 of the coolant system 2002 and into each coolant channel 2012 of the set of coolant channels 2012. One or more of the coolant channels of the set of coolant channels 2012 may have a serpentine pattern. The serpentine pattern may extend from the third side 302, over the apex 408 of the respective chamber, and to the fourth side 304.

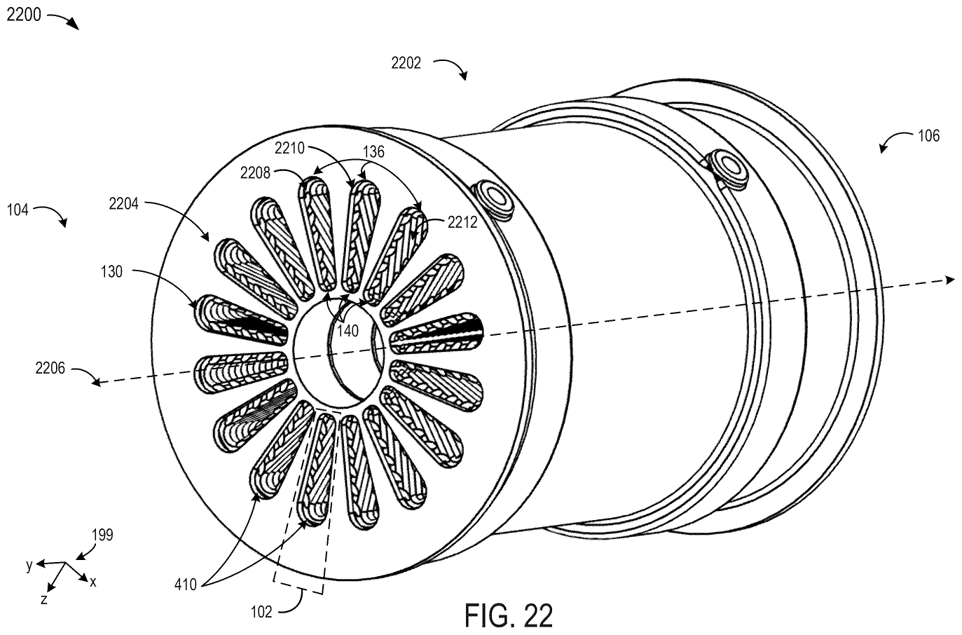

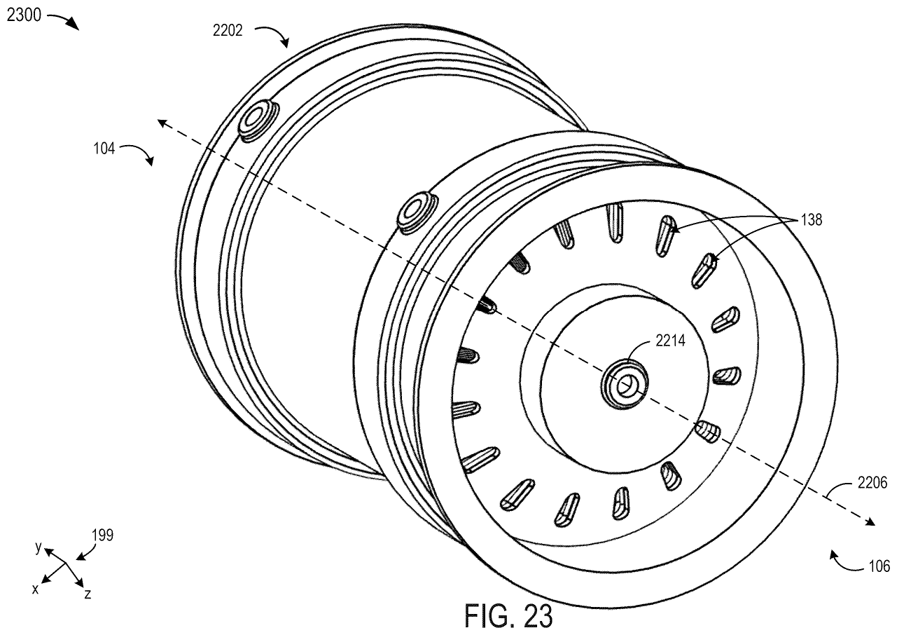

FIGS. 22-28 show a third example of a CCHX including one or more of the CCHX conduit 102 described above. The third example CCHX is also referred to as a hollow cylinder CCHX 2202. FIG. 22 shows a first perspective view 2200 of the hollow cylinder CCHX 2202, and FIG. 23 shows a second perspective view 2300 of the hollow cylinder CCHX 2202. FIGS. 22-23 are described simultaneously herein.

The hollow cylinder CCHX 2202 comprises a set of CCHX conduits 2204, where each CCHX conduit of the set of CCHX conduits 2204 is arranged circumferentially about a central axis 2206 of the hollow cylinder CCHX 2202 with respect to the other CCHX conduits of the set of CCHX conduits 2204. Each CCHX conduit of the set of CCHX conduits 2204 may include an inlet 130 at a first end 104, a gas outlet 138 and a liquid outlet at a second end 106, and a chamber 402 having a teardrop profile and interior walls with a cusp-like structure 410 oriented at a bias angle with respect to a first plane (e.g., the x-z plane, with respect to the axis system 199) that are configured to direct flow of an airstream containing one or more of liquid droplets, humid air, or gas with a condensable vapor from the inlet to the gas outlet 138 and direct liquid droplets out of the airstream and to the liquid outlet 146. For example, one or more of the CCHX conduits of the set of CCHX conduits 2204 may be the CCHX conduit 102 of FIGS. 1-7. Elements of the CCHX conduits of the set of CCHX conduits 2204 having the same name and numbering conventions as elements of the CCHX conduit 102 of FIGS. 1-7 are to be understood as being the same element, and may not be reintroduced for brevity.

Each CCHX conduit of the set of CCHX conduits 2204 is arranged circumferentially about the central axis 2206 of the hollow cylinder CCHX 2202 with respect to the other CCHX conduits of the set of CCHX conduits 2204. The vertex of the teardrop profile of the chamber of each CCHX conduit of the set of CCHX conduits 2204 is proximal to the central axis and an apex of the teardrop profile of each CCHX conduit of the set of CCHX conduits is distal to the central axis 2206. For example, the vertex 140 of the inlet 130 of a first CCHX conduit 2208, the vertex 140 of the inlet 130 of a second CCHX conduit 2210, the vertex 140 of the inlet 130 of a third CCHX conduit 2212, and so on for other vertices of CCHX conduits of the set of CCHX conduits 2204 are aligned about a first circumference. The apex 136 of the inlet 130 of the first CCHX conduit 2208, the apex 136 of the inlet 130 of the second CCHX conduit 2210, the apex 136 of the inlet 130 of the third CCHX conduit 2212, and so on for other apexes of CCHX conduits of the set of CCHX conduits 2204 are aligned about a second circumference, where the second circumference is larger than the first circumference. The inlet 130 of each CCHX conduit of the set of CCHX conduits 2204 may be arranged in the first plane (e.g., the x-z plane, with respect to the axis system 199). The gas outlet 138 of each CCHX conduit of the set of CCHX conduits 2204 may be arranged at the bias angle with respect to the first plane. For example, the bias angle of the gas outlet 138 may be the same as the bias angle of the cusp-like structure 410. The liquid outlet 146 of each CCHX conduit of the set of CCHX conduits 2204 may be arranged parallel to the inlet 130.

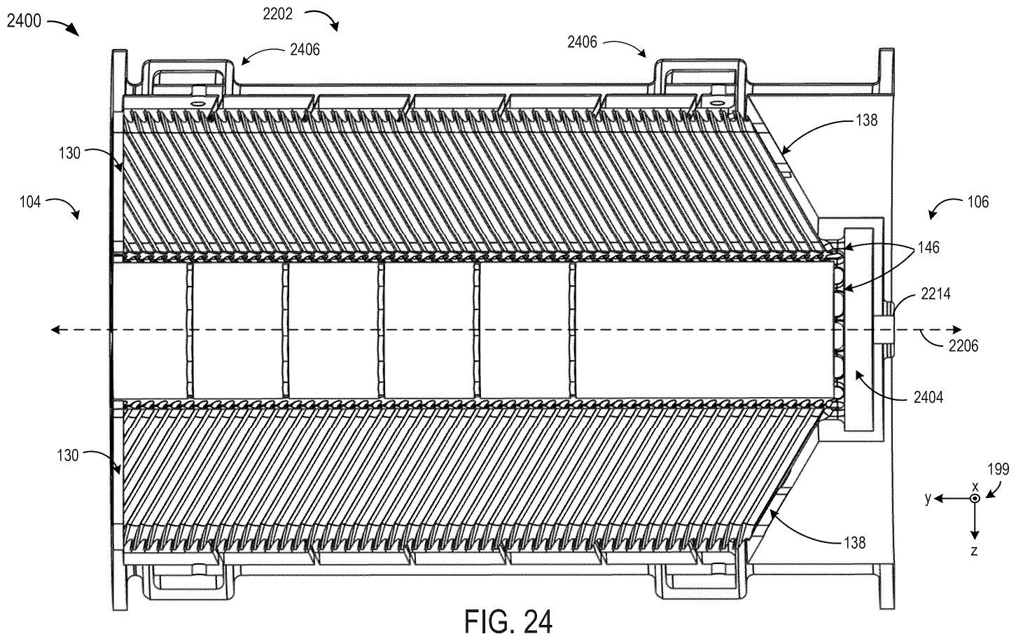

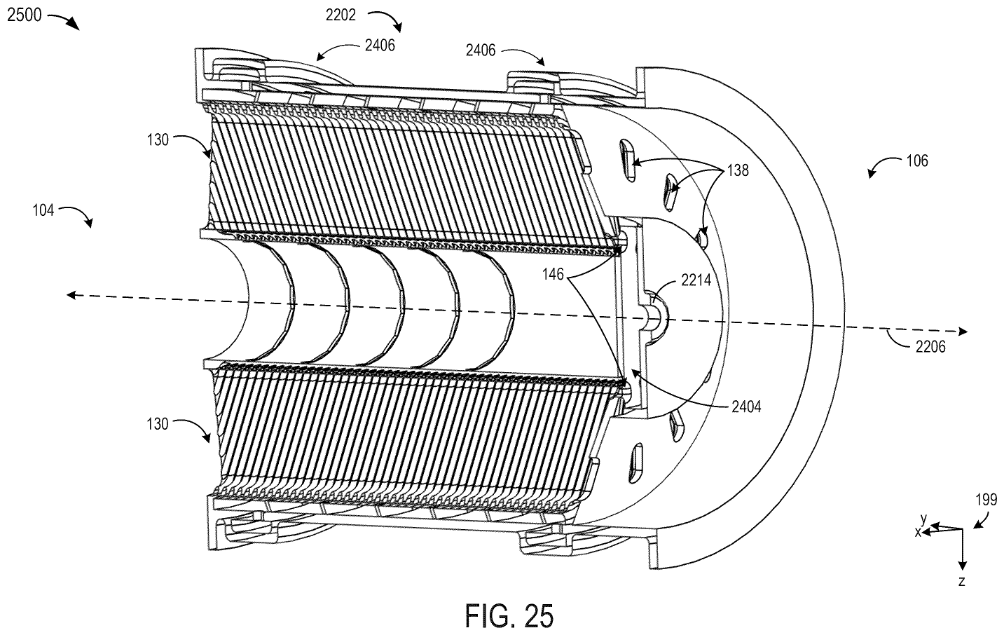

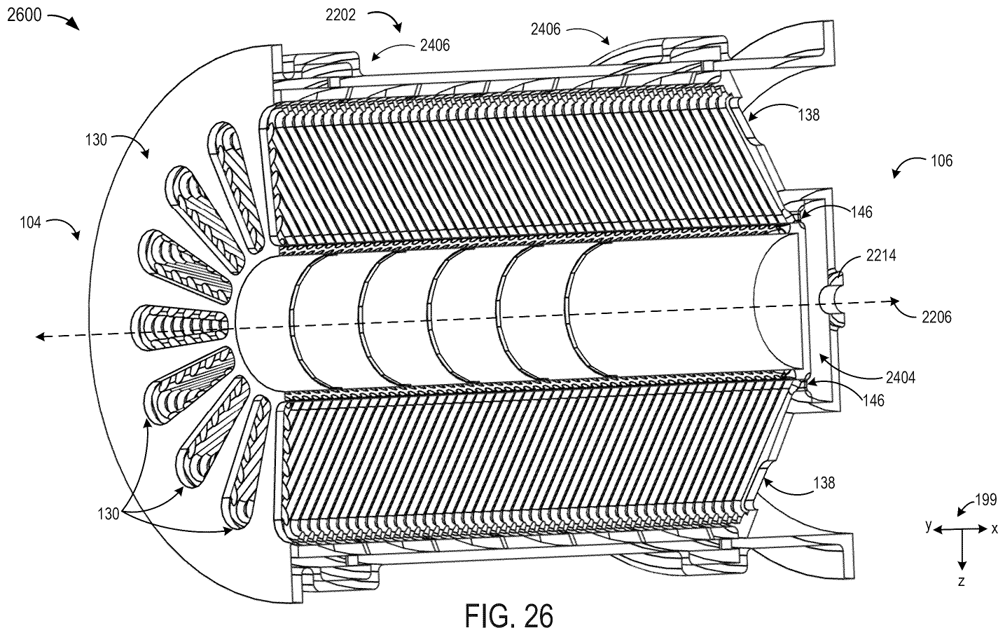

FIG. 24 shows a first cross-sectioned side view 2400 of the hollow cylinder CCHX 2202. FIG. 25 shows a first cross-sectioned perspective view 2500 of the hollow cylinder CCHX 2202. FIG. 26 shows a second cross-sectioned perspective view 2600 of the hollow cylinder CCHX 2202. FIGS. 24-26 are described simultaneously herein. Each CCHX conduit of the set of CCHX conduits 2204 may be fluidly coupled to a liquid outlet channel 2404 of the hollow cylinder CCHX 2202 via the liquid outlet 146 of the respective CCHX conduit. The liquid outlet channel 2404 may include a liquid outlet port 2214.

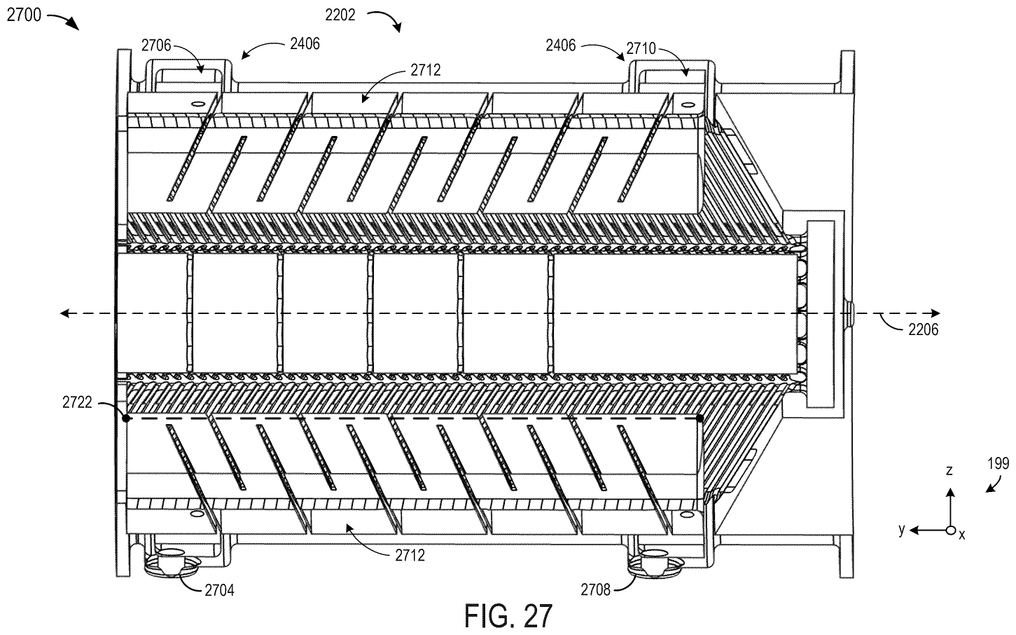

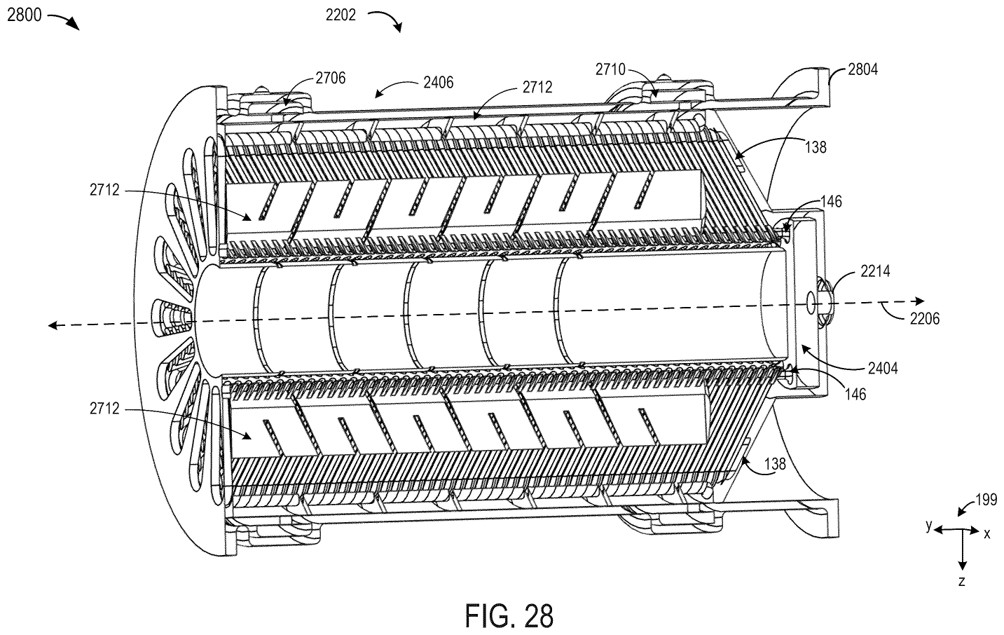

FIG. 27 shows a second cross-sectioned perspective view 2700 of the hollow cylinder CCHX 2202. FIG. 28 shows a third cross-sectioned perspective view 2800 of the hollow cylinder CCHX 2202. FIGS. 27 and 28 are described simultaneously herein. The hollow cylinder CCHX 2202 further comprises a coolant system 2406 configured to cool the set of CCHX conduits 2204. The coolant system 2406 is positioned external to and fluidly isolated from chambers of the set of CCHX conduits 2204. The coolant system 2406 may include a coolant inlet 2704 on a first channel 2706, a coolant outlet 2708 on a second channel 2710, and a set of coolant channels 2712 that are fluidly coupled to the first channel 2706 and the second channel 2710. The first channel 2706 and the second channel 2710 of the coolant system 2406 of the hollow cylinder CCHX 2202 circumferentially surround at least a portion of each CCHX conduit of the set of CCHX conduits 2204. The first channel 2706 is positioned near the first end 104 of the hollow cylinder CCHX 2202 (e.g., near the inlet 130 of each CCHX conduit of the set of CCHX conduits 2204). The first channel 2706 extends circumferentially about (e.g., circumferentially surrounds) a portion of a body of the hollow cylinder CCHX 2202. The second channel 2710 is positioned posterior to the first channel 2706, with respect to the axis system 199, near the second end 106 of the hollow cylinder CCHX 2202. The second channel 2710 is parallel to the first channel 2706. The second channel 2710 extends circumferentially about a portion of the body of the hollow cylinder CCHX 2202. The first channel 2706 and the second channel 2710 may have the same or different heights.

Each coolant channel of the set of coolant channels 2712 may be positioned with respect to a corresponding CCHX conduit of the set of CCHX conduits 2204, as described with respect to FIGS. 1-7. For example, a coolant channel 2712 of the first CCHX conduit 2208 extends along the third side 302 and the fourth side 304 of the hollow cylinder CCHX 2202 along a coolant channel length 2722 of the first CCHX conduit 2208. The coolant channel 2712 further extends along the coolant channel length 2722 of the first CCHX conduit 2208 parallel to the apex 408 of the first CCHX conduit 2208, where the portion of the coolant channel 2712 superior to the apex 408 of the chamber 402 fluidly couples the portions of the coolant channel 2712 on the third side 302 and the fourth side 304 of the chamber 402. Each conduit of the set of CCHX conduits 2204 may have a similar coolant channel configuration. In addition to cooling a respective conduit (e.g., when coolant is flowed through the coolant channel), a coolant channel may cool a conduit positioned immediately laterally adjacent (e.g., parallel) to the respective conduit in the circumferential arrangement. For example, a coolant channel 2712 of the second CCHX conduit 2210 has a portion on the third side 302 of the chamber 402 of the second CCHX conduit 2210 that is between the second CCHX conduit 2210 and the third CCHX conduit 2212 and that extends along the coolant channel length 2722, and a portion on the fourth side 304 of the chamber 402 of the second CCHX conduit 2210 that is between the second CCHX conduit 2210 and the first CCHX conduit 2208 for the coolant channel length 2722. The coolant channel 2712 may be in close enough proximity to the first CCHX conduit 2208 and the third CCHX conduit 2212 that the coolant channel 2712 may provide cooling to the first CCHX conduit 2208 and the third CCHX conduit 2212 in addition to the second CCHX conduit 2210. This may be the case for multiple coolant channels of the hollow cylinder CCHX 2202. Additionally and/or alternatively, because the CCHX conduits of the set of CCHX conduits 2204 are arranged circumferentially around the central axis 2206, the coolant channels 2712 may be shared among CCHX conduits. For example, coolant channels may be shared between adjacent CCHX conduits (e.g., there may not be walls between coolant channels for each conduit).

Each coolant channel of the set of coolant channels 2712 of the hollow cylinder CCHX 2202 may be fluidly coupled to the first channel 2706 of the coolant system 2406 at the first end 104, and fluidly coupled to the second channel 2710 of the coolant system 2406 at the second end 106. Further, each coolant channel of the set of coolant channels 2712 may be fluidly connected to each other at a circumference that surrounds the apex of each chamber of the CCHX conduits of the set of CCHX conduits 2204. Coolant may flow into the coolant system 2406 via the coolant inlet 2704, flow from the coolant inlet 2704 through the first channel 2706 of the coolant system 2406 and into each coolant channel 2712 of the set of coolant channels 2712 via a coupling through hole. One or more of the coolant channels of the set of coolant channels 2712 may have a serpentine pattern. The serpentine pattern may extend from the third side 302, over the apex 408 of the respective chamber, and to the fourth side 304. Coolant may flow both within a single coolant channel from the first end 104 to the second end 106, along the serpentine path, cooling CCHX conduits on either side of the single coolant channel, and may flow among multiple coolant channels of the set of coolant channels 2712.

The hollow cylinder CCHX 2202 may further include a collar 2804 at the second end 106 that circumferentially surrounds the liquid outlet channel 2404 and the second end 106 of the set of CCHX conduits 2204, where the second end 106 includes the gas outlets 138 and the liquid outlets 146. Cylindrical forms provide reduced dimensions for manifolding for drain ports as compared to linear planar deployments. Additionally, a cylindrical form-factor provides the least external wall-volume for the same number and length of channels. Thus, lower mass and volumes can be achieved for the same target thermal performance. The reduced transverse length scales associated with a cylindrical unit also result in less susceptibility to transverse g-perturbations.

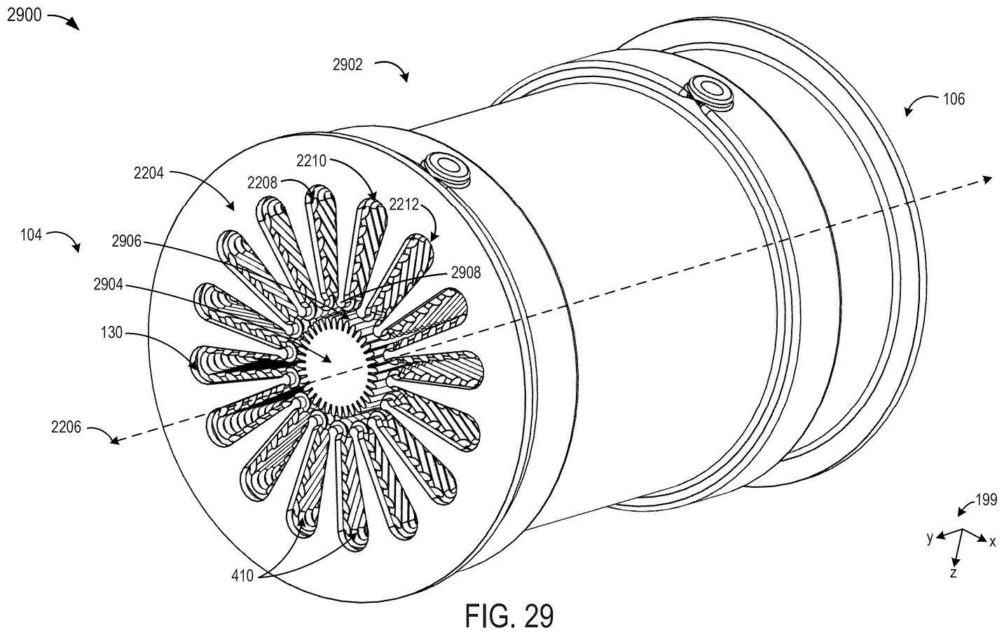

FIGS. 29-36 illustrate an example CCHX that may be a version of the hollow cylinder CCHX 2202 described with respect to FIGS. 22-28, thus includes a similar design and elements that are configured to direct liquid droplets out of an airstream containing one or more of liquid droplets, humid air, or gas with a condensable vapor. The example CCHX described with respect to FIGS. 29-36 is referred to herein as a cusped center cylinder (CCC) CCHX 2902. It may be understood that the CCC CCHX 2902 has the same elements, configurations, and functionalities as the hollow cylinder CCHX 2202, as are described with respect to FIGS. 22-28. Additional and/or alternative elements, configurations, and/or functionalities of the CCC CCHX 2902 are described herein with respect to FIGS. 29-36. Elements of the CCC CCHX 2902 having the same name and numbering conventions as elements of the hollow cylinder CCHX 2202 of FIGS. 22-28 are to be understood as being the same element, and may not be reintroduced for brevity.

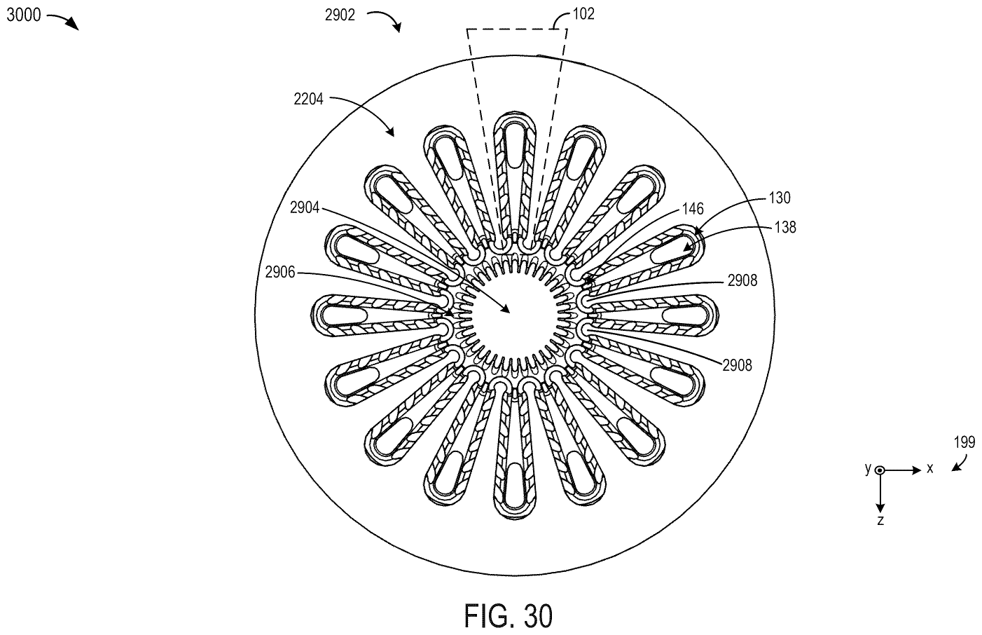

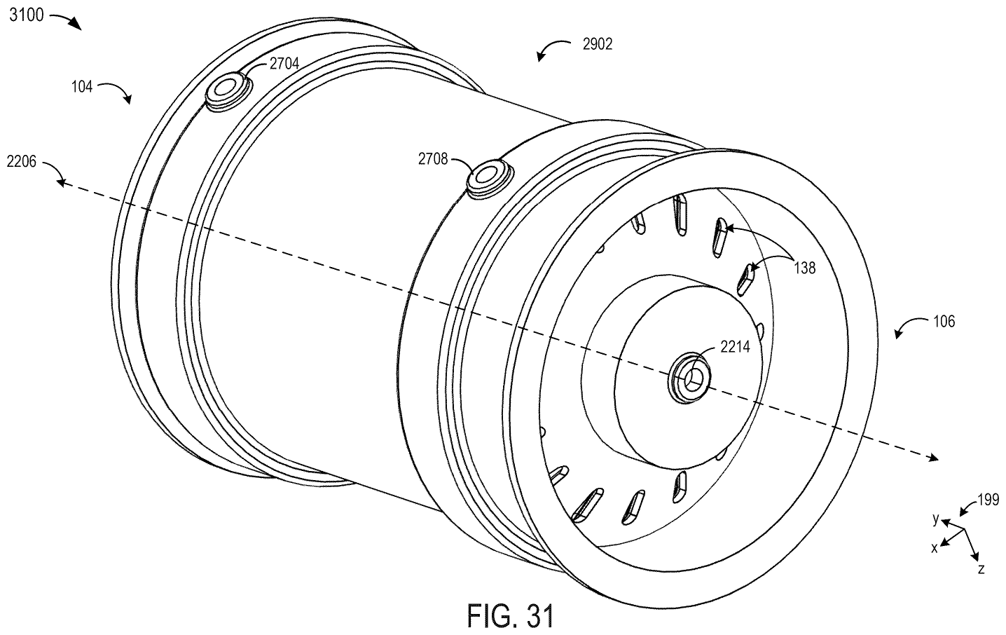

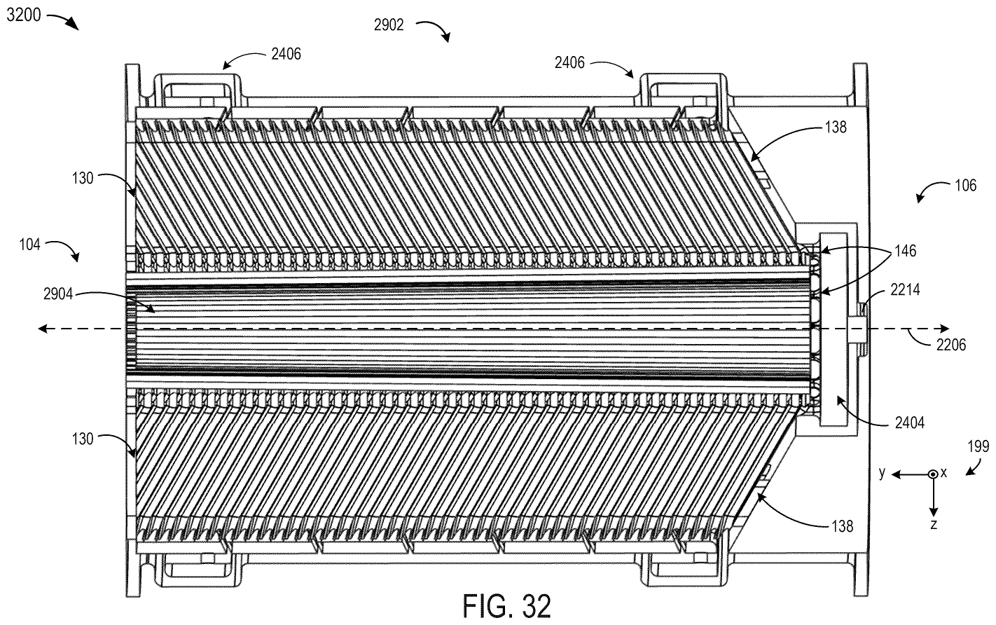

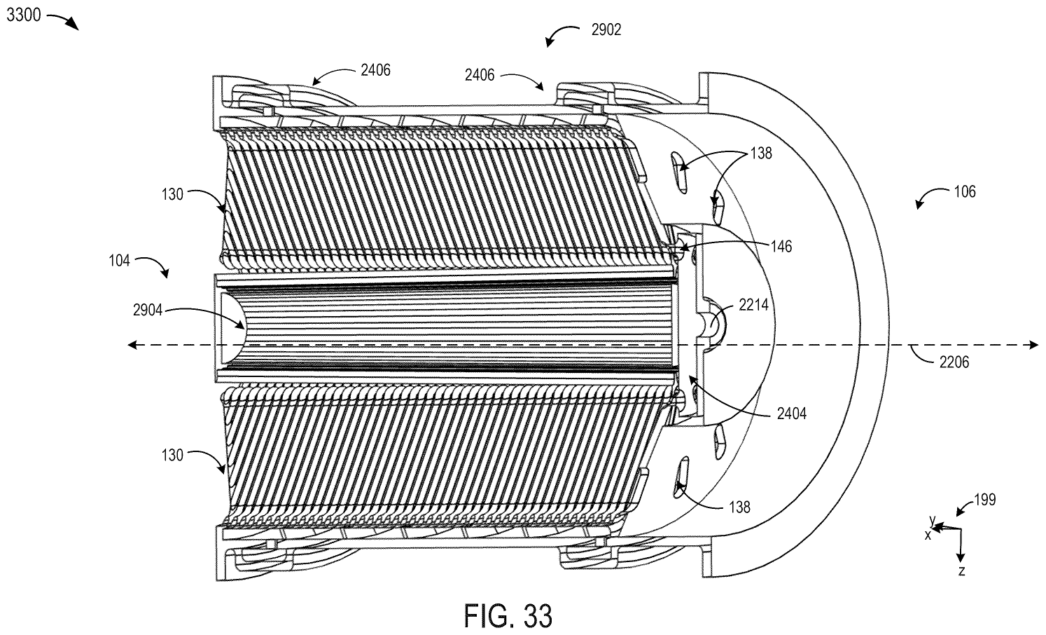

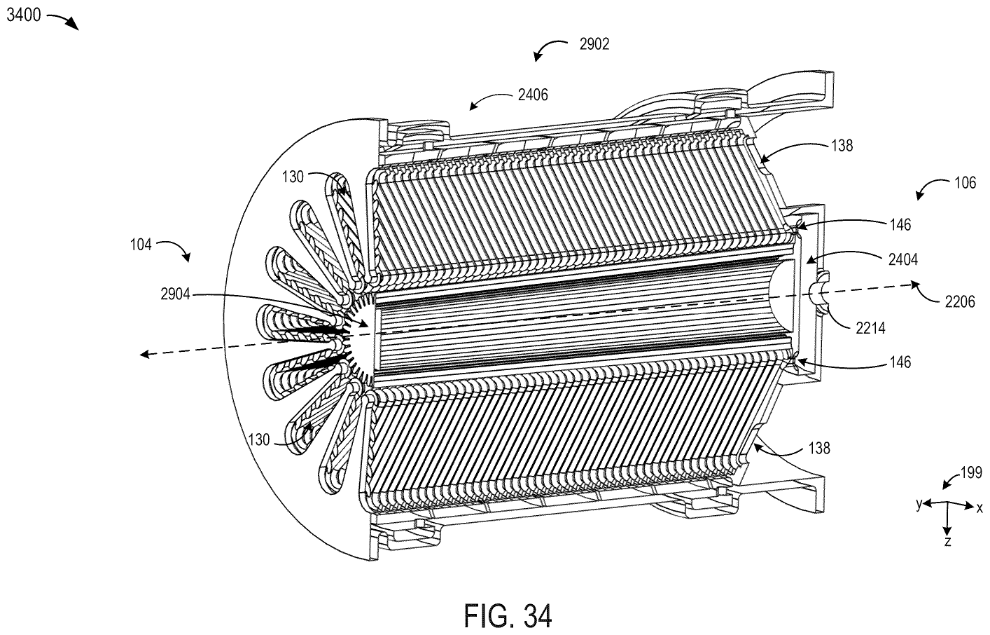

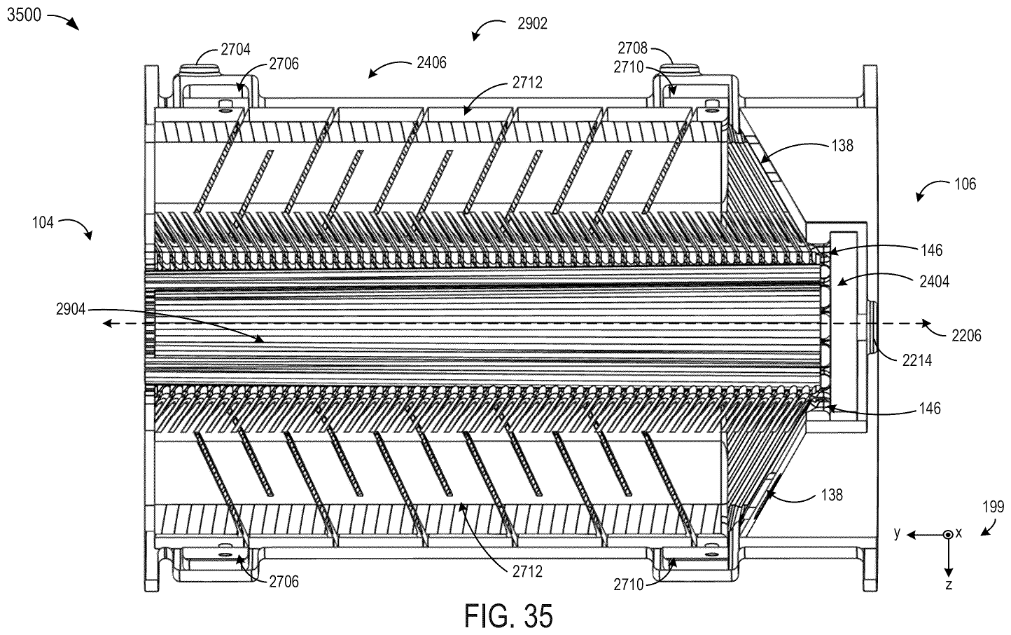

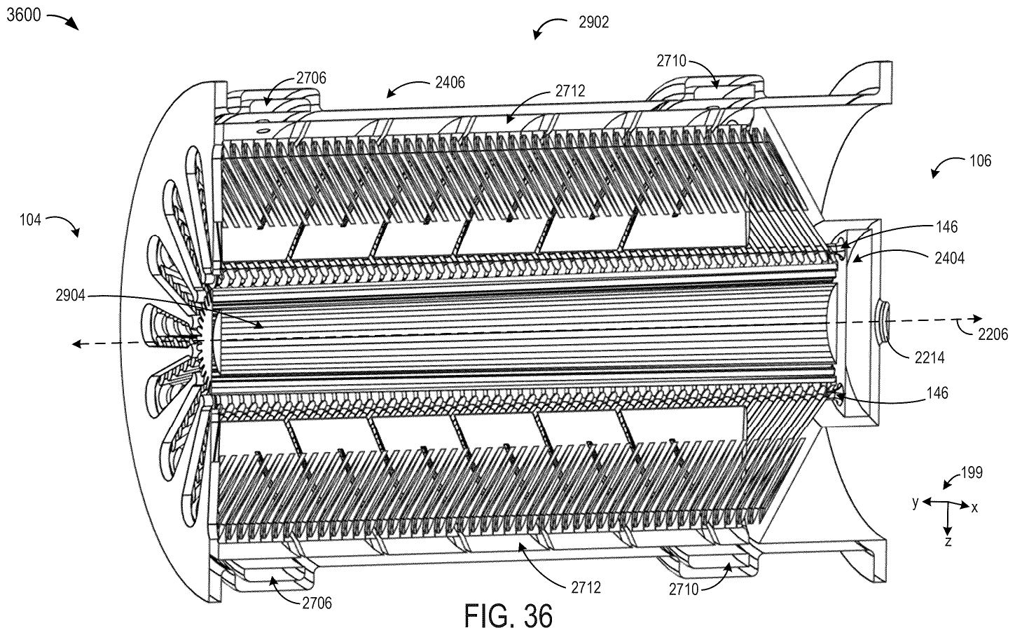

FIG. 29 shows a first perspective view 2900 of the CCC CCHX 2902. FIG. 30 shows a first end view 3000 of the CCC CCHX 2902. FIG. 31 shows a second perspective view 3100 of the CCC CCHX 2902. FIG. 32 shows a first cross-sectioned side view 3200 of the CCC CCHX 2902. FIG. 33 shows a first cross-sectioned perspective view 3300 of the CCC CCHX 2902. FIG. 34 shows a second cross-sectioned perspective view 3400 of the CCC CCHX 2902. FIG. 35 shows a second cross-sectioned side view 3500 of the CCC CCHX 2902. FIG. 36 shows a third cross-sectioned perspective view 3600 of the CCC CCHX 2902. FIGS. 29-36 are described simultaneously.

Wherein the hollow cylinder CCHX 2202 is hollow along the central axis 2206 about which the set of CCHX conduits 2204 are circumferentially positioned, the CCC CCHX 2902 includes a cusped shaft 2904 that extends along the central axis 2206 of the CCC CCHX 2902. The cusped shaft 2904 comprises a cusp-like structure 410 that extends radially from the cusped shaft 2904 towards the set of CCHX conduits 2204 and is oriented parallel to the central axis 2206. The cusped shaft 2904 is configured to direct flow of the airstream containing one or more of liquid droplets, humid air, or gas with the condensable vapor from cusp-like structure of the set of CCHX conduits to the liquid outlet channel, similar to the cusp-like structure 410 of the CCHX conduit, as described with respect to FIGS. 1-7. Liquid may be wicked from the cusp-like structure 410 of the CCHX conduits to the cusped shaft, which may operate as further wicking structure (e.g., operate same as vertex in closed conduit) to wick liquid towards liquid reservoir at bottom center. The cusped shaft 2904 may include elliptical ribs that have the same and/or different dimensions (e.g., height, width, gap width) as the elliptical ribs of the cusp-like structure 410 of the CCHX conduits. There is a circumferential gap 2906 between the cusped shaft 2904 and the vertices of the CCHX conduits.

Each CCHX conduit of the set of CCHX conduits 2204 is arranged circumferentially about the central axis 2206 of the CCC CCHX 2902 with respect to the other CCHX conduits of the set of CCHX conduits 2204. The vertex of the teardrop profile of the chamber of each CCHX conduit of the set of CCHX conduits 2204 is proximal to the central axis and an apex of the teardrop profile of each CCHX conduit of the set of CCHX conduits is distal to the central axis 2206. The vertex 140 of the teardrop profile of each CCHX conduit 102 is open to the central axis 2206 of the CCC CCHX 2902, such that each CCHX conduit of the set of CCHX conduits 2204 are fluidly connected to the cusp-like structure 410 of the cusped shaft 2904. Elliptical ribs of the cusp-like structure 410 of each CCHX conduit of the set of CCHX conduits 2204 may be continuous among the set of CCHX conduits 2204. For example, a first elliptical rib may extend around a median 2908 between the first CCHX conduit 2208 and the second CCHX conduit 2210.

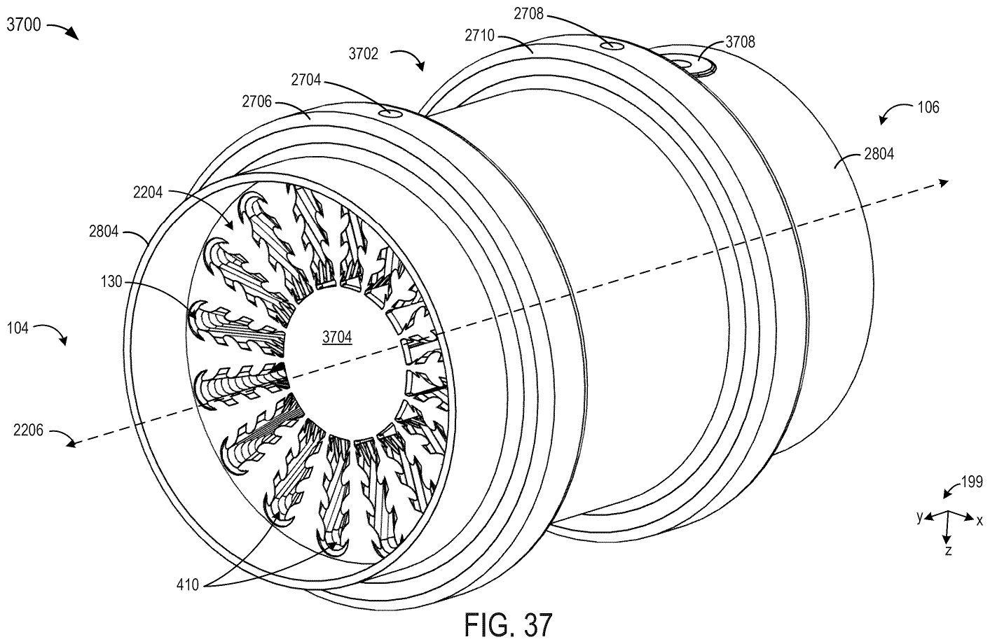

FIGS. 37-46 illustrate an example CCHX that may be a version of the hollow cylinder CCHX 2202 described with respect to FIGS. 22-28 thus includes a similar design and elements that are configured to direct liquid droplets out of an airstream containing one or more of liquid droplets, humid air, or gas with a condensable vapor. The example CCHX described with respect to FIGS. 37-46 is referred to herein as a center channel cylinder (CHC) CCHX 3702. It may be understood that the CHC CCHX 3702 has the same elements, configurations, and functionalities as the hollow cylinder CCHX 2202, as are described with respect to FIGS. 22-28. Additional and/or alternative elements, configurations, and/or functionalities of the CHC CCHX 3702 are described herein with respect to FIGS. 37-46. Elements of the CHC CCHX 3702 having the same name and numbering conventions as elements of the hollow cylinder CCHX 2202 of FIGS. 22-28 are to be understood as being the same element, and may not be reintroduced for brevity.

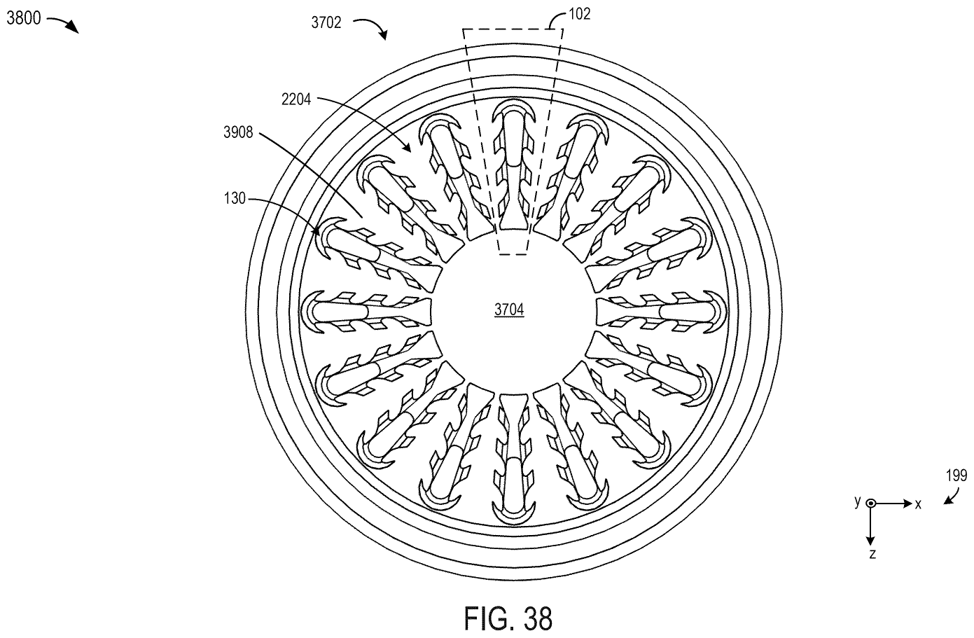

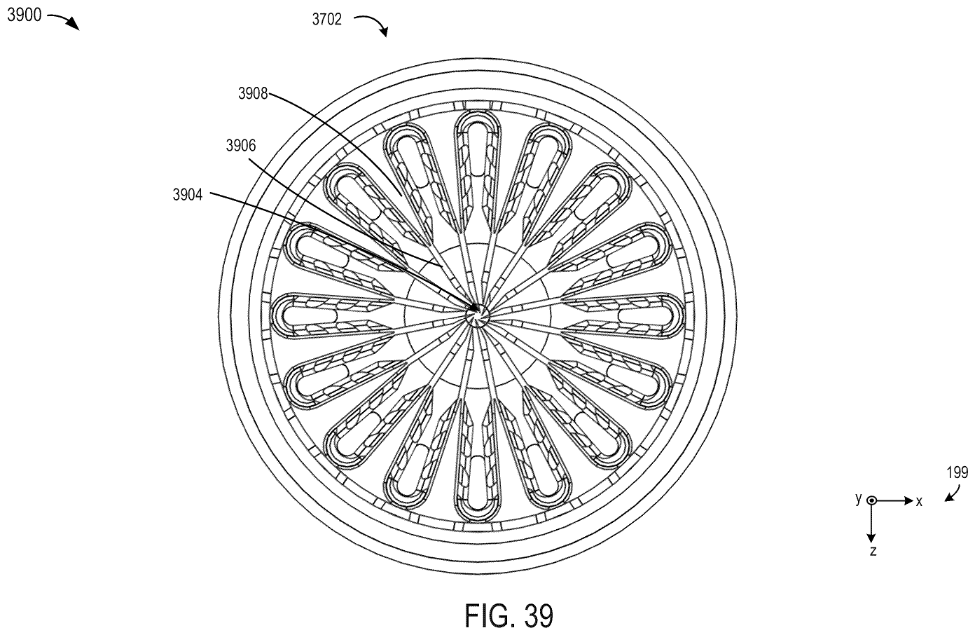

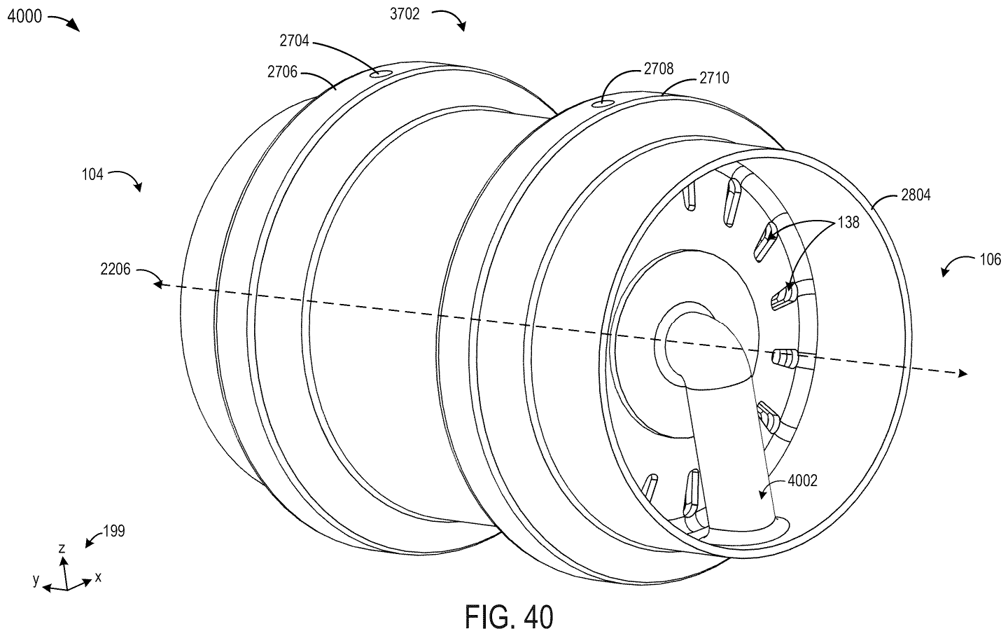

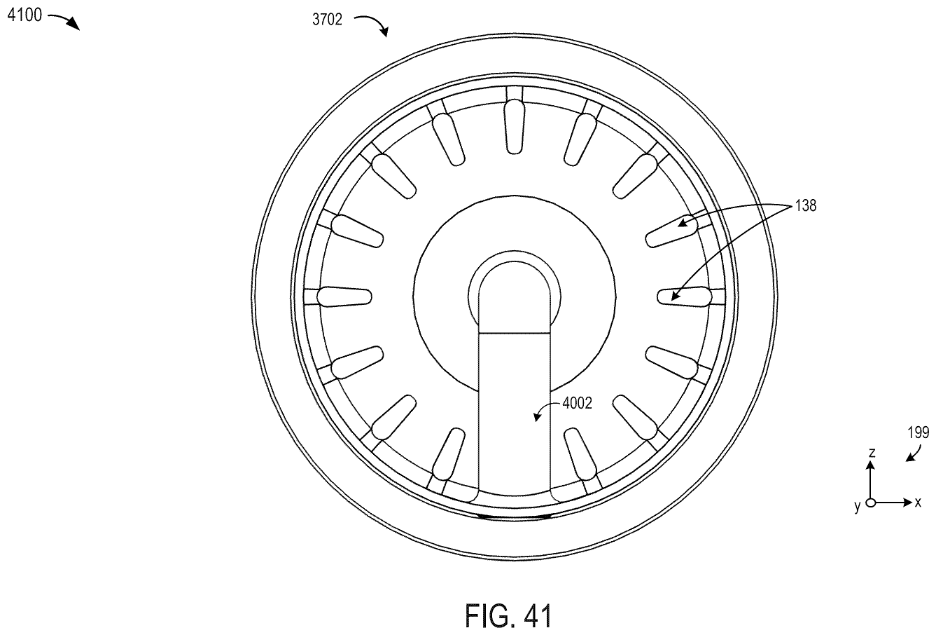

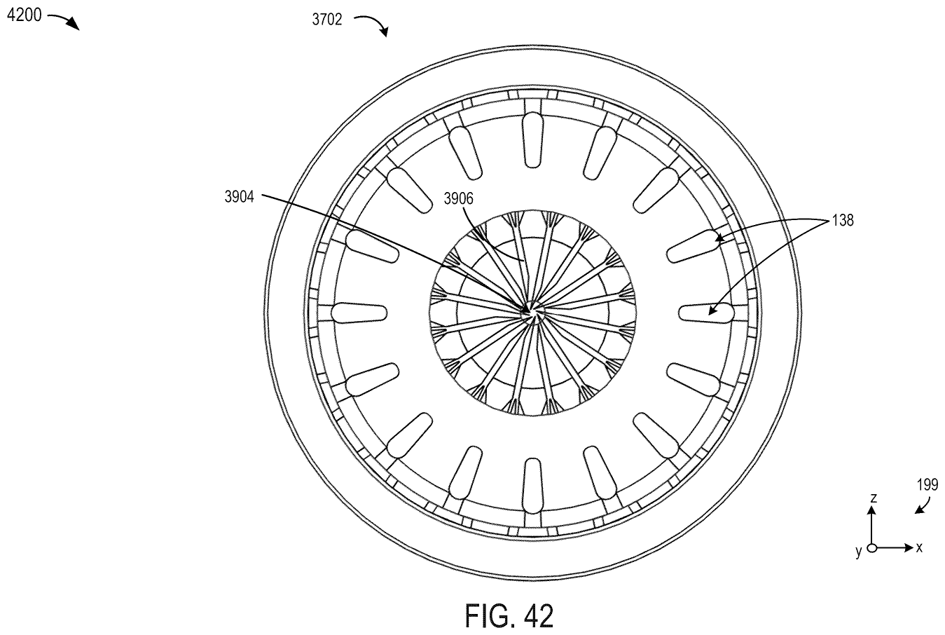

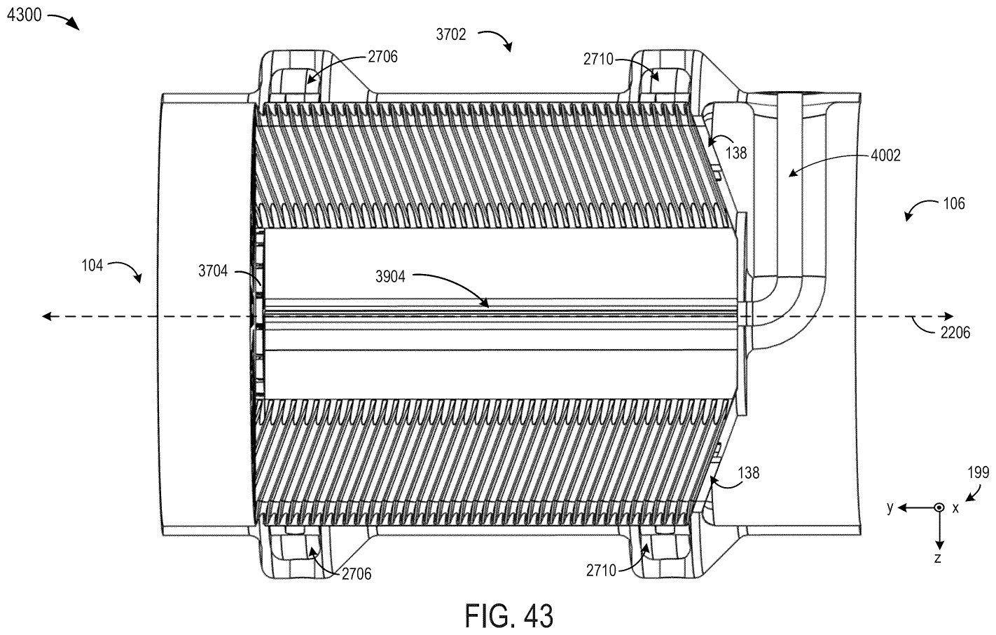

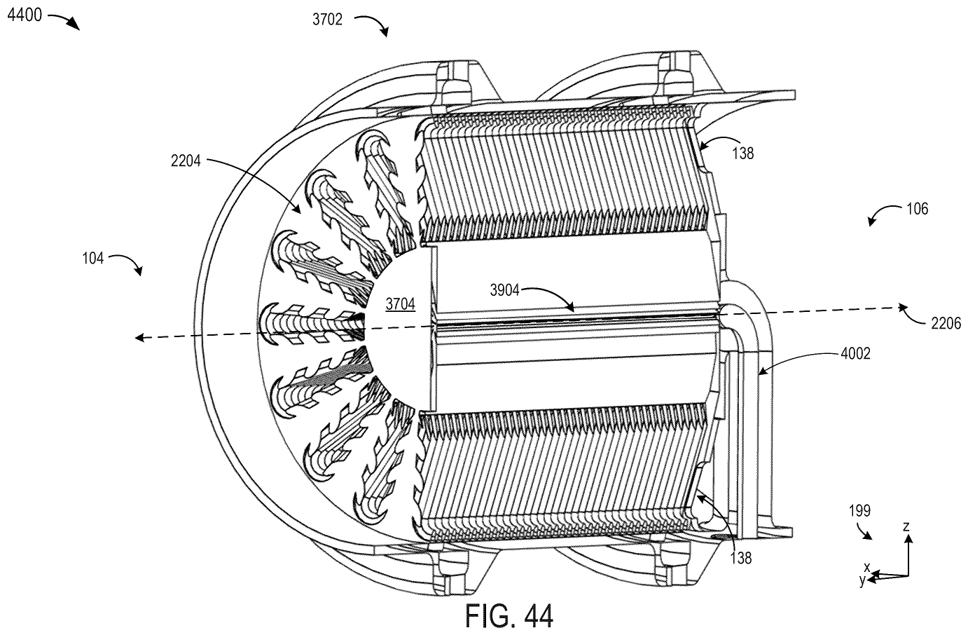

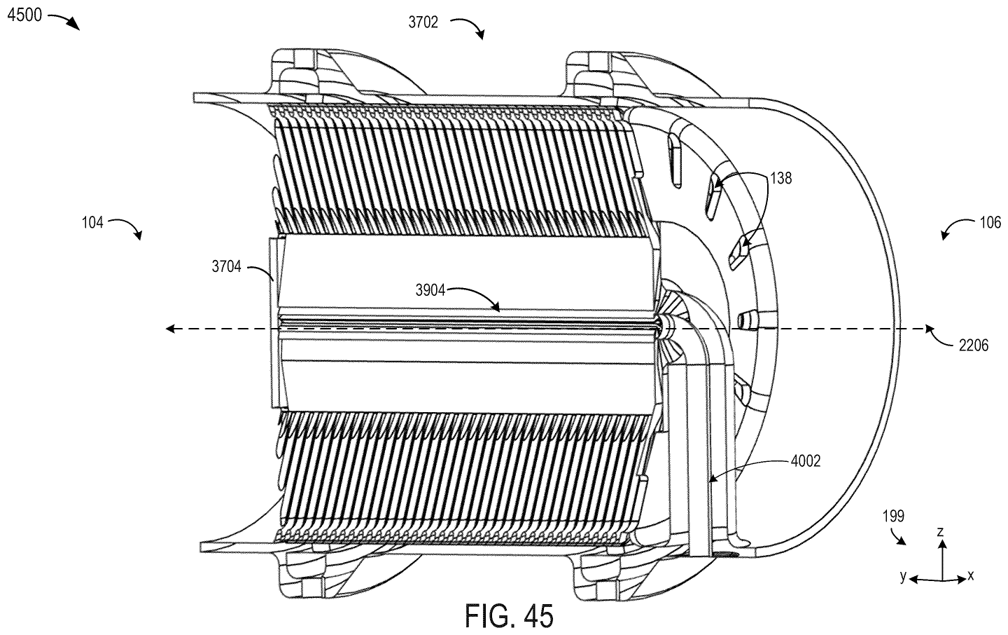

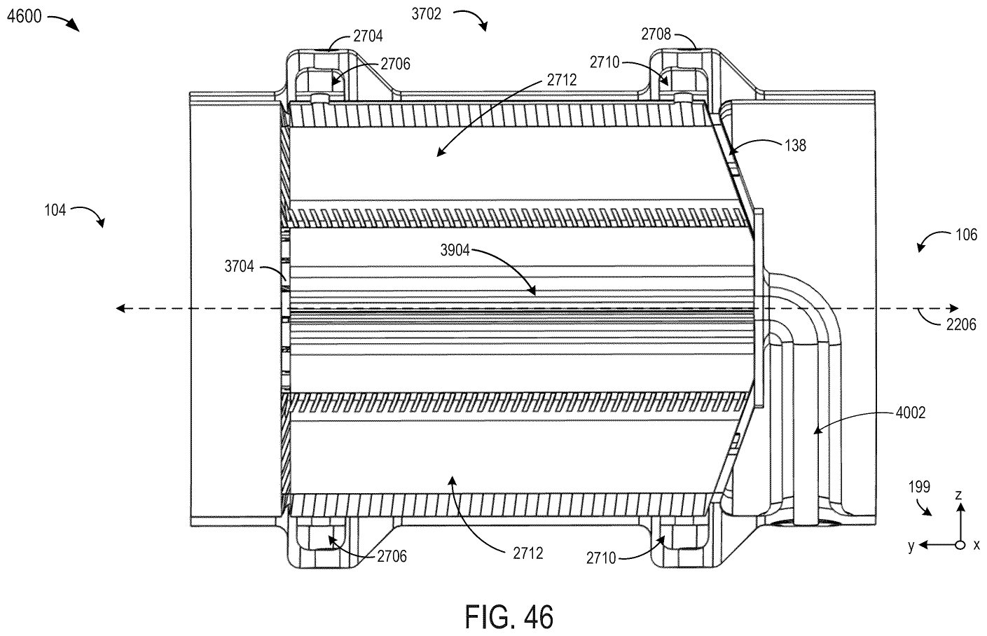

FIG. 37 shows a first perspective view 3700 of the CHC CCHX 3702 that includes the CCHX conduit. FIG. 38 shows a shows a first end view 3800 of the CHC CCHX 3702. FIG. 39 shows a cross-sectioned view 3900 of the CHC CCHX from a first end 104. FIG. 40 shows a second perspective view 4000 of the CHC CCHX 3702. FIG. 41 shows a second end view 4100 of the CHC CCHX 3702. FIG. 42 shows a cross-sectioned view 4200 of the CHC CCHX 3702 from a second end 106, opposite the first end 104. FIG. 43 shows a first cross-sectioned side view 4300 of the CHC CCHX 3702. FIG. 44 shows a first cross-sectioned perspective view 4400 of the CHC CCHX 3702. FIG. 45 shows a second cross-sectioned perspective view 4500 of the CHC CCHX 3702. FIG. 46 shows a second cross-sectioned side view 4600 of the CHC CCHX 3702. FIGS. 37-46 are described simultaneously.

The hollow cylinder CCHX 2202 is hollow along the central axis 2206 about which the set of CCHX conduits 2204 are circumferentially positioned. The CHC CCHX 3702 may not be hollow and instead includes a central drain 3904 that is axially aligned with the central axis 2206 of the CHC CCHX 3702. Each CCHX conduit of the set of CCHX conduits 2204 is fluidly coupled to the central drain 3904 by a vane 3906 that extends from a median 3908 between of each CCHX conduit of the set of CCHX conduits 2204, to the central drain 3904. The central drain 3904 includes a cap 3704 at the first end 104, where the cap 3704 functions as the vertex of each CCHX conduit of the set of CCHX conduits 2204 at the first end 104 (e.g., the vertex 140 of the inlet 130). The cap 3704 may extend a portion of the conduit length of each CCHX conduit of the set of CCHX conduits 2204, as shown in FIG. 43. FIGS. 39 and 42-46 illustrate that the vertex of each chamber of the set of CCHX conduits 2204 is open to the central drain 3904 (e.g., via the vane 3906 on either side of the respective CCHX conduit 102 Liquid that is condensed and wicked out of the airstream by the cusp-like structure 410 of each CCHX conduit of the set of CCHX conduits 2204 is directed to the central drain 3904, which directs the liquid into a liquid drain 4002. The liquid drain 4002 may extend towards an exterior of the CHC CCHX 3702. The CHC CCHX 3702 further includes a collar 2804 at each of the first end 104 and the second end 106. At the second end 106, the collar 2804 includes a liquid outlet port 3708 to which the liquid drain 4002 is fluidly coupled. One or more of the collar 2804 at the first end 104 and the second end 106 may be used to couple the CHC CCHX 3702 to other elements and/or to a system. Additionally, the coolant channels (e.g., the first channel 2706 and/or the second channel 2710) may each include one or more coolant inlets 2704 and coolant outlets 2708, respectively.

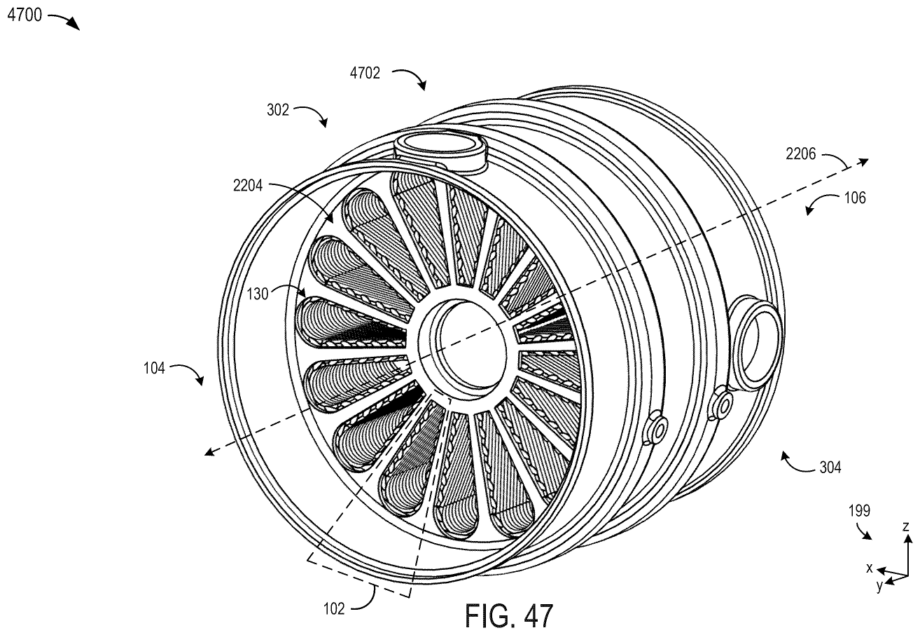

FIGS. 47-55 illustrate an example CCHX that may be a version of the hollow cylinder CCHX 2202 described with respect to FIGS. 22-28, thus includes a similar design and elements that are configured to direct liquid droplets out of an airstream containing one or more of liquid droplets, humid air, or gas with a condensable vapor. The example CCHX described with respect to FIGS. 47-55 is referred to herein as a circumferential cooling cylinder (CFC) CCHX 4702. It may be understood that the CFC CCHX 4702 has the same elements, configurations, and functionalities as the hollow cylinder CCHX 2202, as are described with respect to FIGS. 22-28. Additional and/or alternative elements, configurations, and/or functionalities of the CFC CCHX 4702 are described herein with respect to FIGS. 47-55. Elements of the CFC CCHX 4702 having the same name and numbering conventions as elements of the hollow cylinder CCHX 2202 of FIGS. 22-28 are to be understood as being the same element, and may not be reintroduced for brevity.

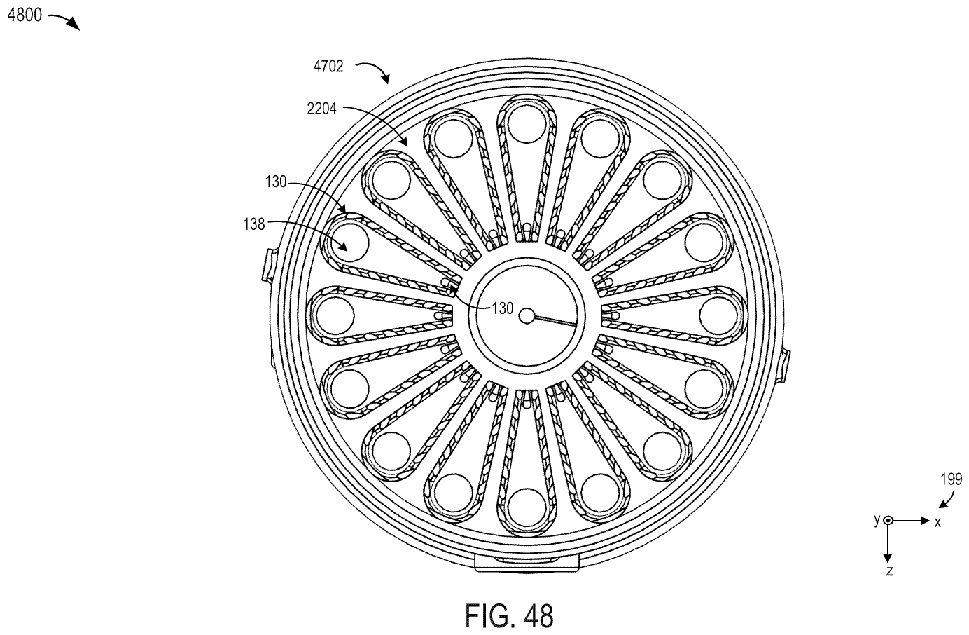

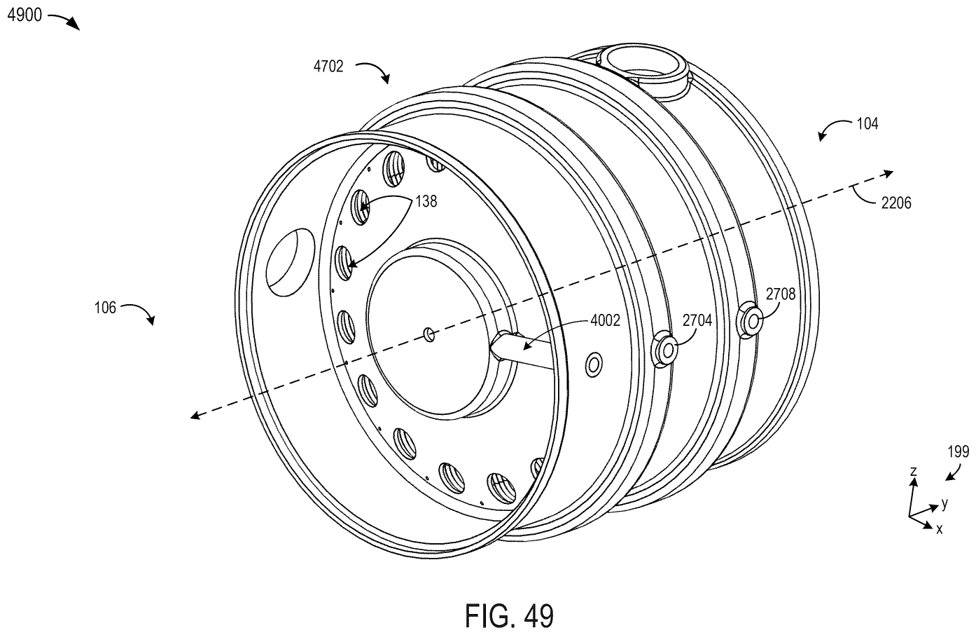

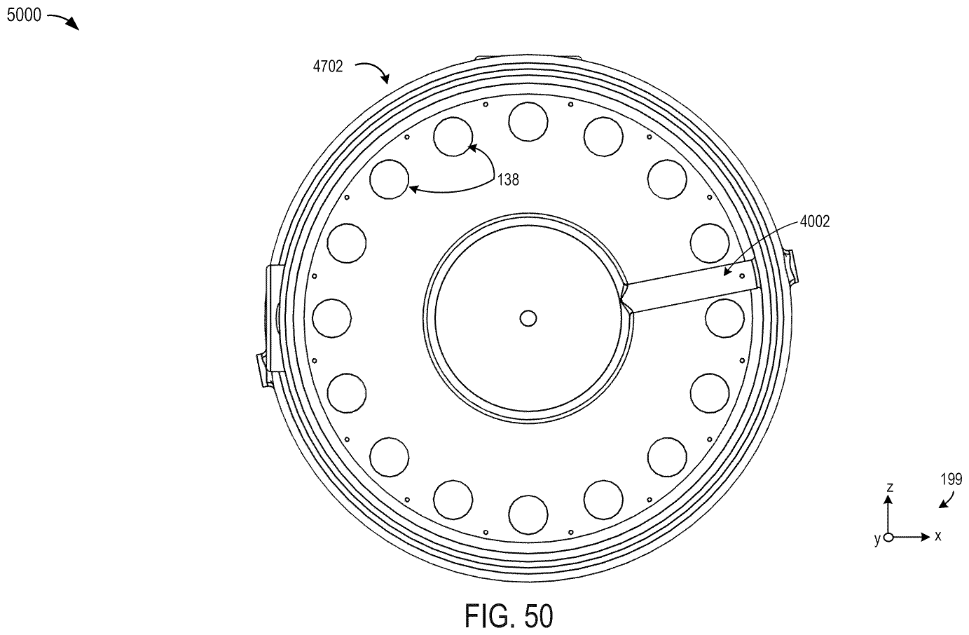

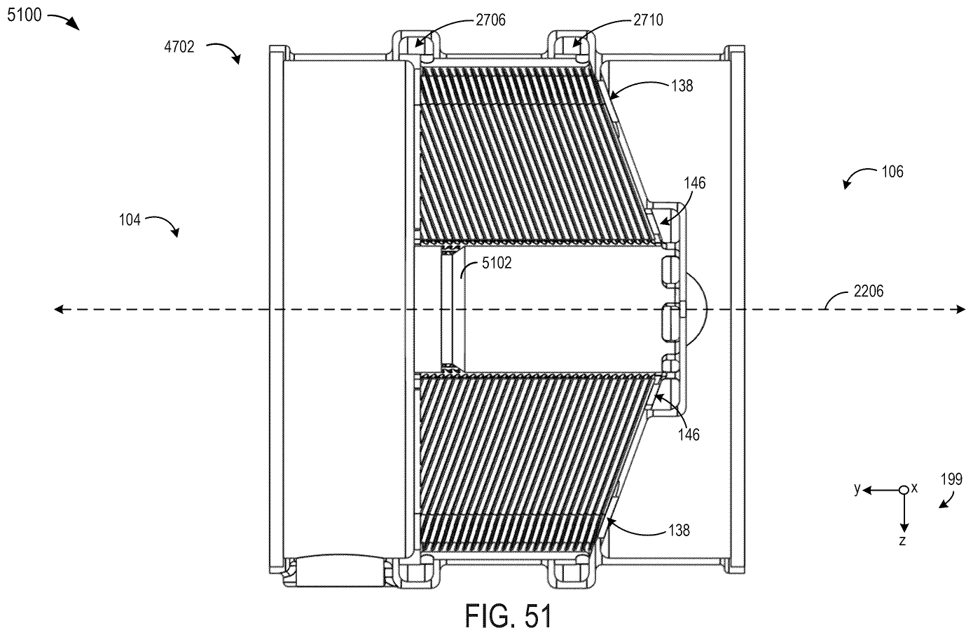

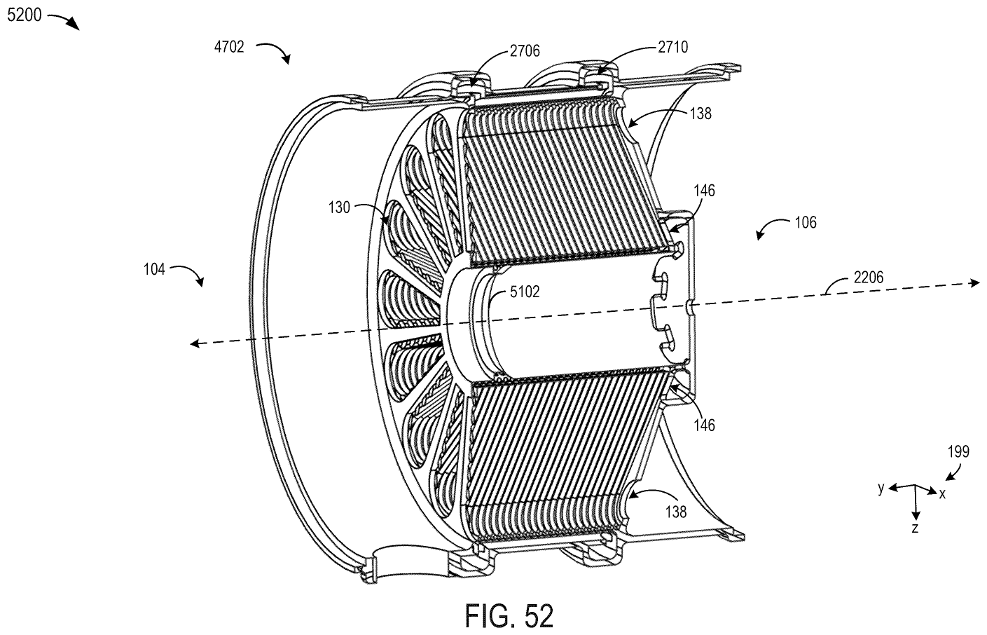

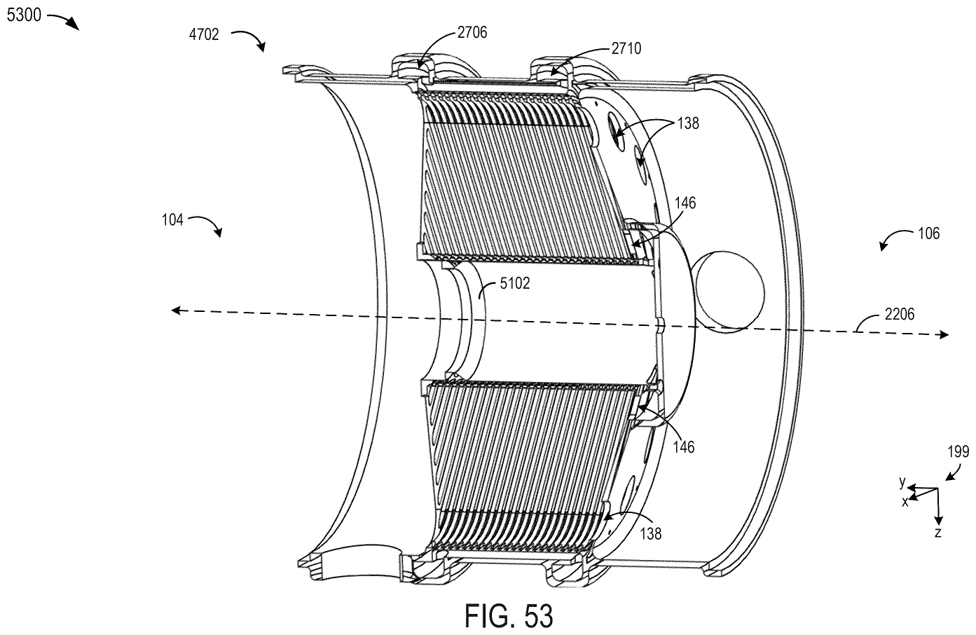

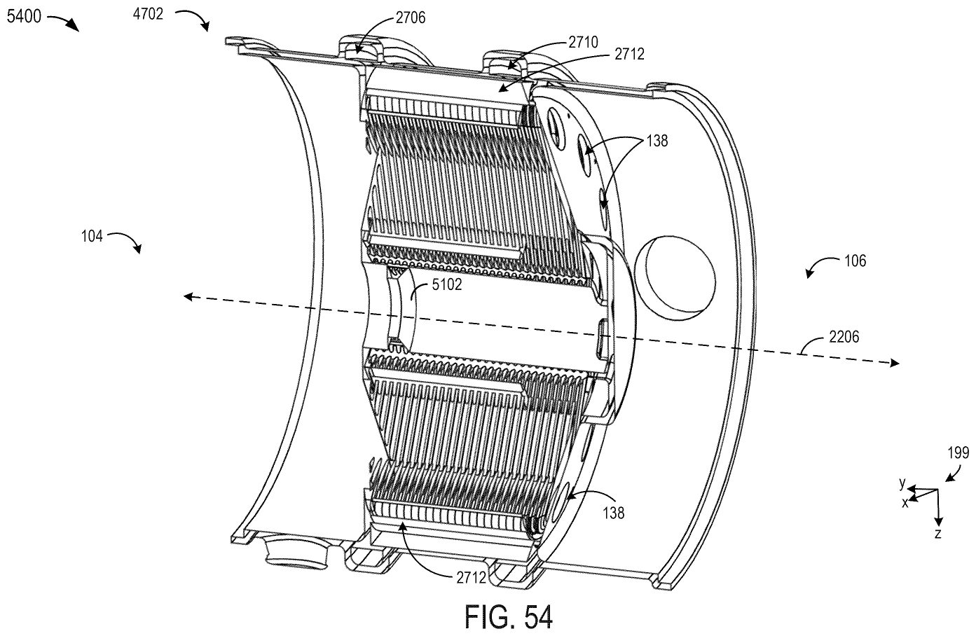

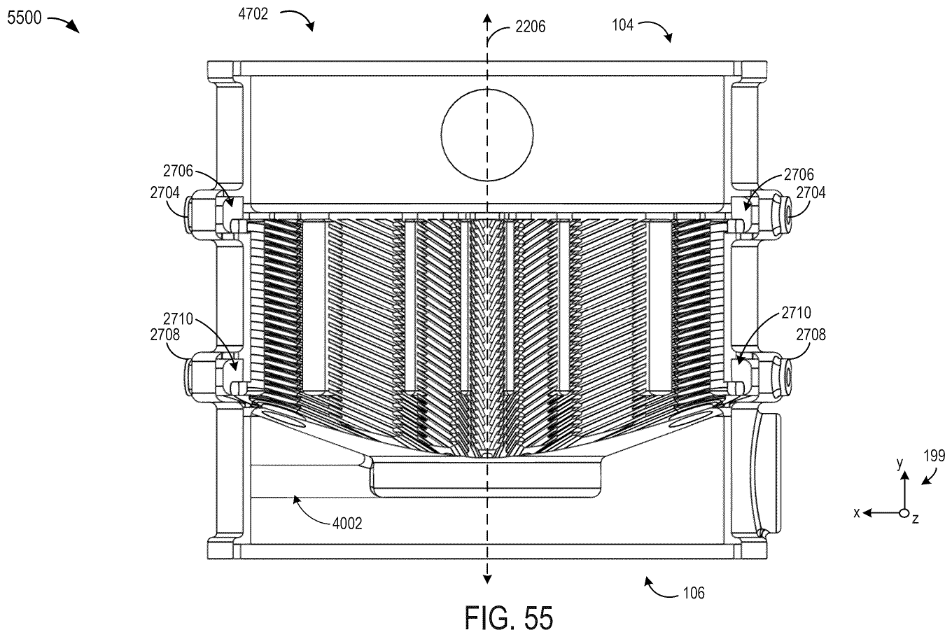

FIG. 47 shows a first perspective view 4700 of the CFC CCHX 4702 that includes the CCHX conduit 102. FIG. 48 shows a shows a first end view 4800 of the CFC CCHX 4702. FIG. 49 shows a second perspective view 4900 of the CFC CCHX 4702. FIG. 50 shows a second end view 5000 of the CFC CCHX 4702. FIG. 51 shows a first cross-sectioned side view 5100 of the CFC CCHX 4702. FIG. 52 shows a first cross-sectioned perspective view 5200 of the CFC CCHX 4702. FIG. 53 shows a second cross-sectioned perspective view 5300 of the CFC CCHX 4702. FIG. 54 shows a third cross-sectioned perspective view 5400 of the CFC CCHX 4702. FIG. 55 shows a second cross-sectioned side view 5500 of the CFC CCHX 4702. FIGS. 47-55 are described simultaneously.

The hollow cylinder CCHX 2202 is hollow along the central axis 2206 about which the set of CCHX conduits 2204 are circumferentially positioned. The CFC CCHX 4702 comprises a circumferential coolant channel 5102 that extends circumferentially within a hollow center of the CCHX and is fluidly coupled to the first channel and the second channel of the coolant system.

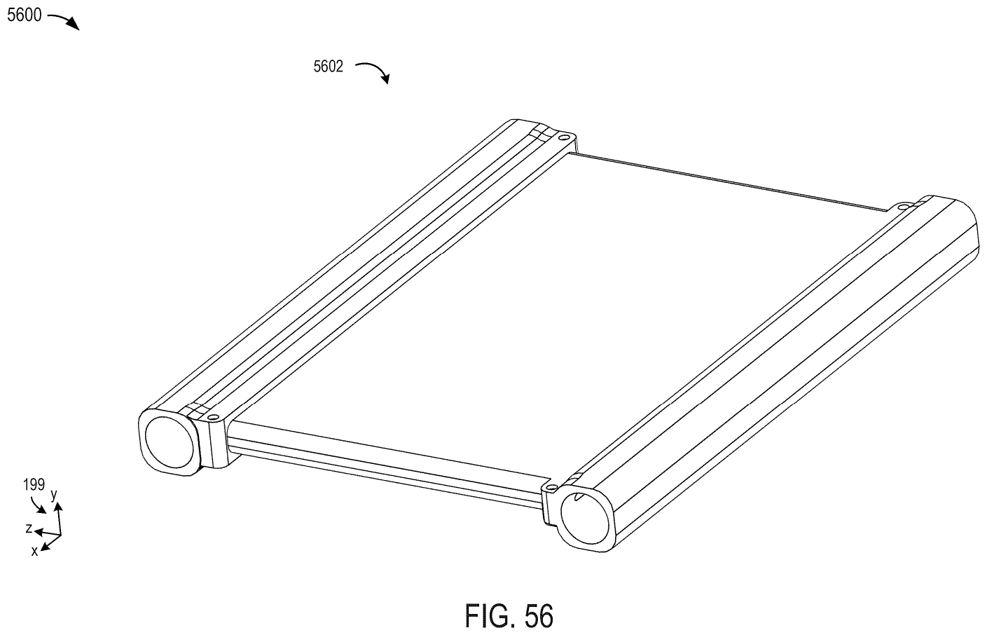

FIGS. 56-65 illustrate an example CCHX that may be a version of the vertical stack CCHX 802 described with respect to FIGS. 8-15, thus includes a similar design and elements that are configured to direct liquid droplets out of an airstream containing one or more of liquid droplets, humid air, or gas with a condensable vapor. The example CCHX described with respect to FIGS. 56-65 is referred to herein as a herringbone CCHX 5602. It may be understood that the herringbone CCHX 5602 has the same elements, configurations, and functionalities as the vertical stack CCHX 802, as are described with respect to FIGS. 8-15. Additional and/or alternative elements, configurations, and/or functionalities of the herringbone CCHX 5602 are described herein with respect to FIGS. 56-66. Elements of the herringbone CCHX 5602 having the same name and numbering conventions as elements of the vertical stack CCHX 802 of FIGS. 8-15 are to be understood as being the same element, and may not be reintroduced for brevity.

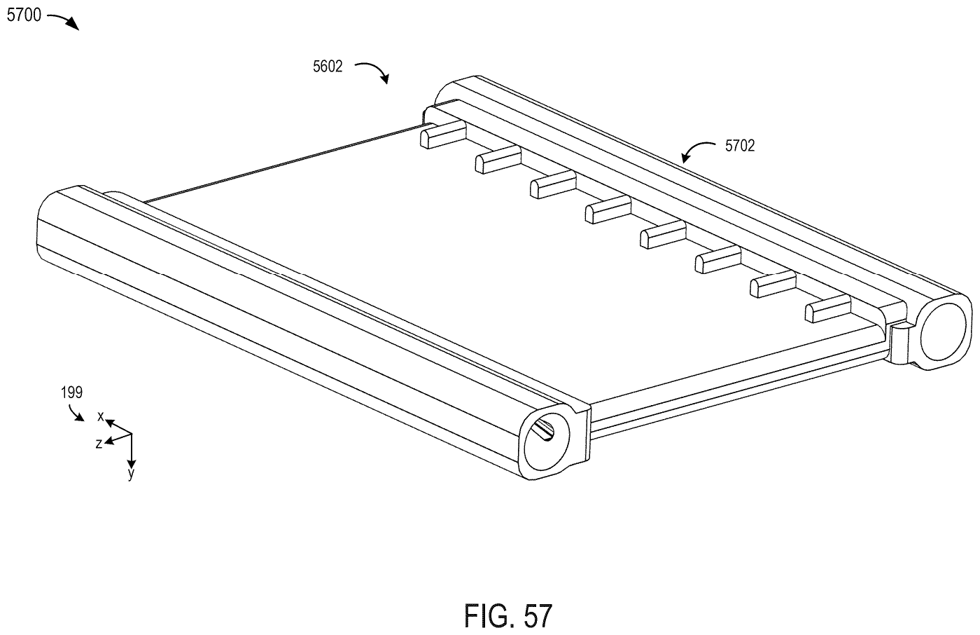

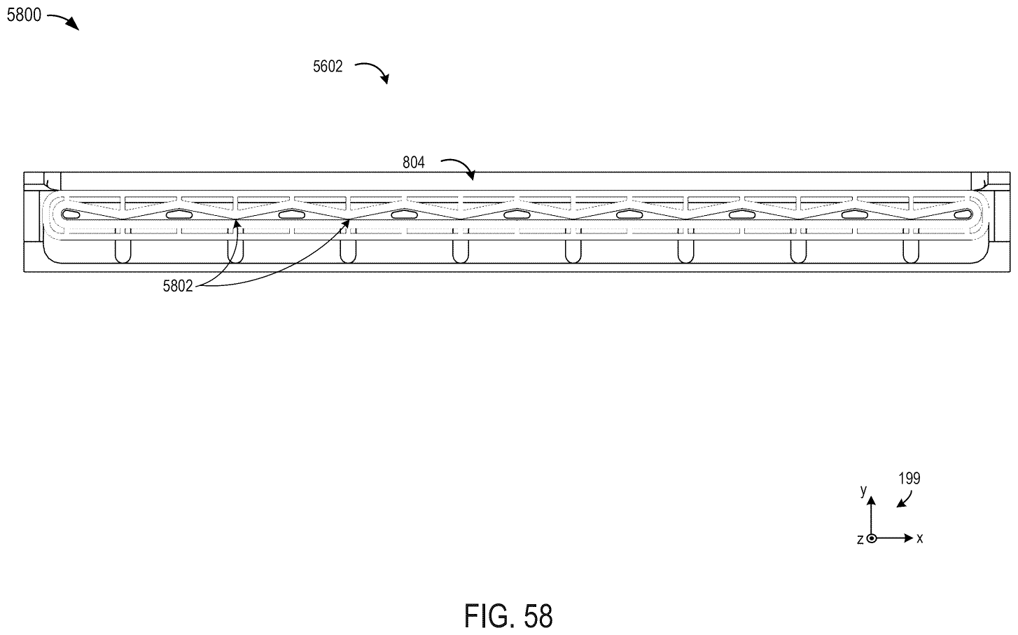

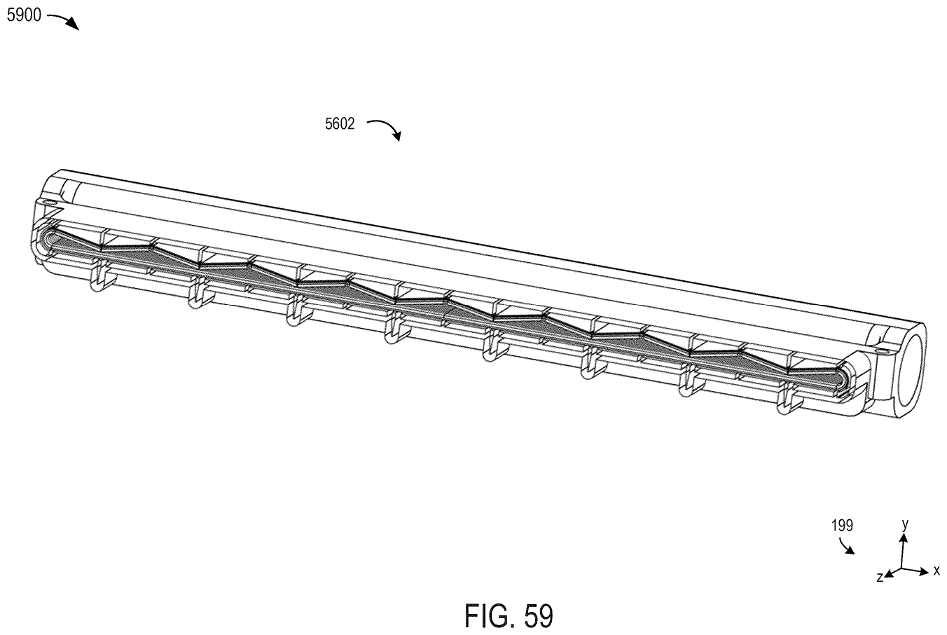

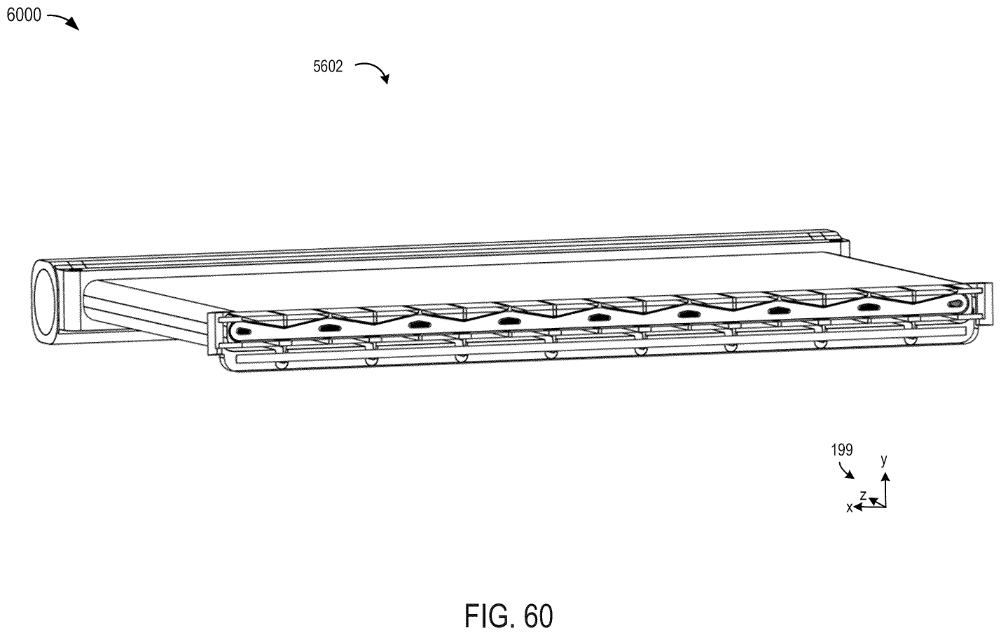

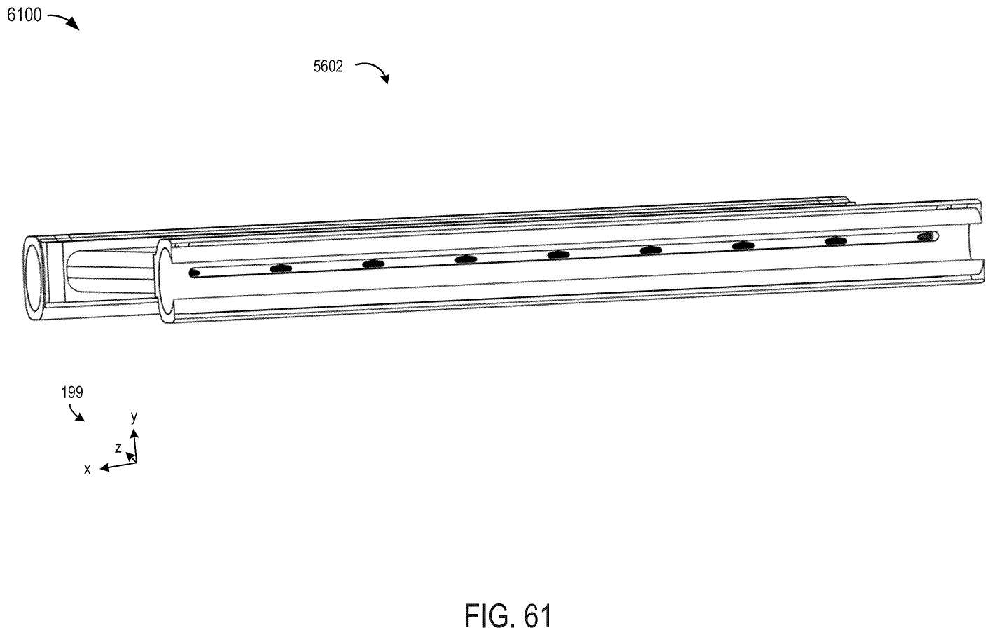

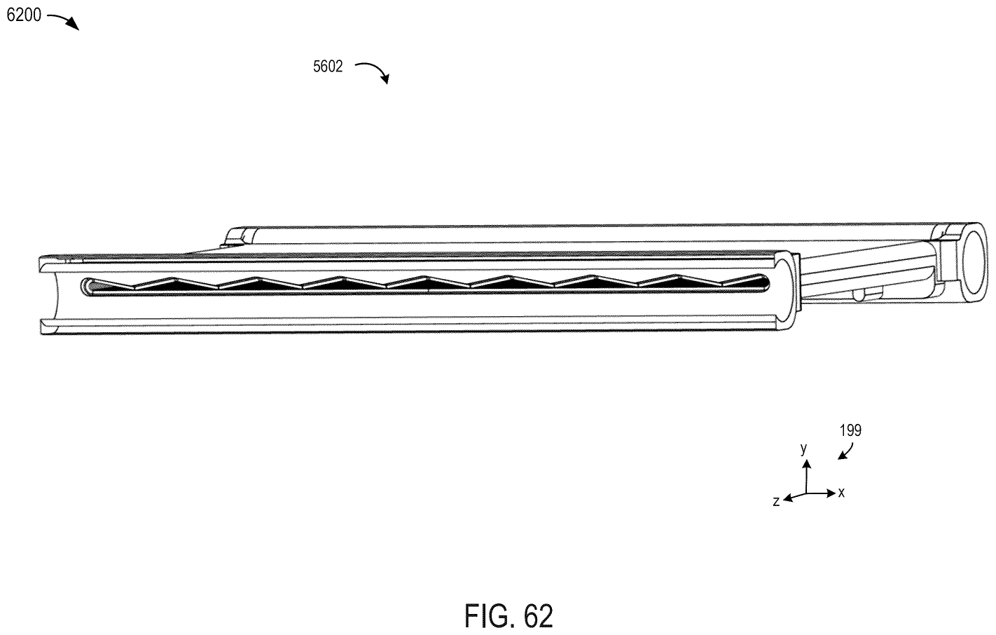

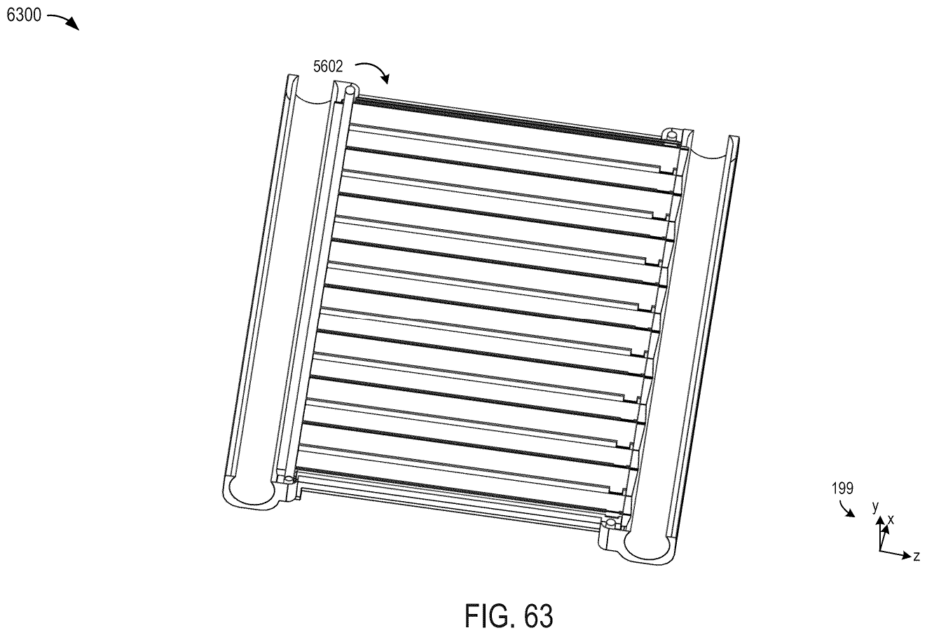

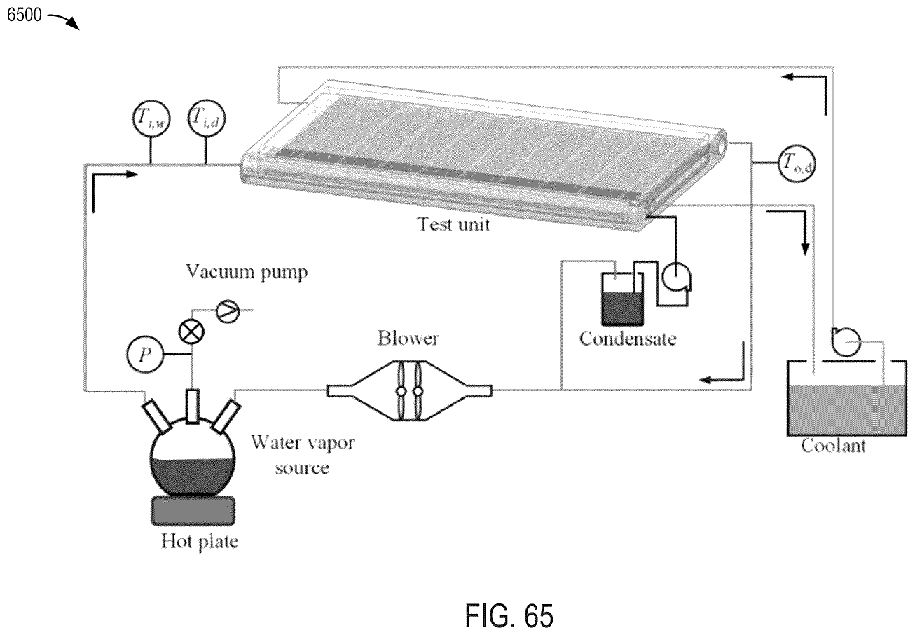

FIG. 56 shows a first perspective view 5600 of the herringbone CCHX 5602 that includes the CCHX conduit 102. FIG. 57 shows a second perspective view 5700 of the herringbone CCHX 5602. FIG. 58 shows a first cross-sectioned side view 5800 of the herringbone CCHX 5602. FIG. 59 shows a first cross-sectioned perspective view 5900 of the herringbone CCHX 5602. FIG. 60 shows a second cross-sectioned perspective view 6000 of the herringbone CCHX 5602. FIG. 61 shows a third cross-sectioned perspective view 6100 of the herringbone CCHX 5602. FIG. 62 shows a fourth cross-sectioned perspective view 6200 of the herringbone CCHX 5602. FIG. 63 shows a fifth cross-sectioned perspective view 6300 of the herringbone CCHX 5602. FIG. 64 shows a sixth cross-sectioned perspective view 6400 of the herringbone CCHX 5602. FIG. 65 shows an example condensing heat assembly 6500 including the herringbone CCHX 5602. FIGS. 56-65 are described simultaneously herein.

The herringbone CCHX 5602 provides linear parallelization of CCHX conduits, where the CCHX conduits of the set of CCHX conduits 804 are arranged in an alternating position such that the chambers of the CCHX conduits partially overlap and are fluidly connected. Chamber cross-talk is enabled. Alternating parallel teardrop chambers may accumulate condensate in 11 vertices 5802 where a drain port manifold 5702 draws off condensate. The condensate may be returned to a system chemical sorbent flow loop, as shown in FIG. 6500. The herringbone CCHX 5602 may provide passive condensate separation, such as for removing water vapor from a humid CO₂ stream.

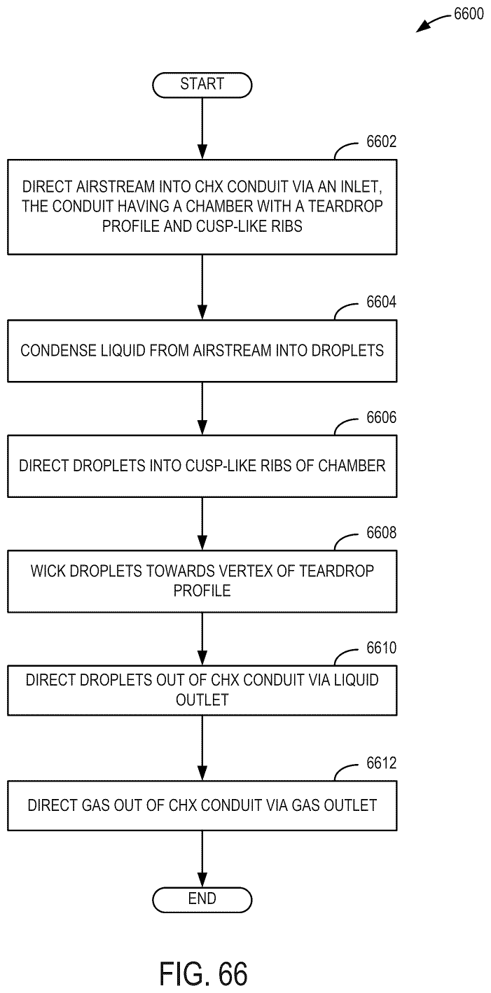

FIG. 66 shows a flow chart of a method 6600 for extracting liquid from a humid airstream using a CCHX conduit, such as the CCHX conduit 102 of FIGS. 1-7. The method 6600 may also be implemented in one or more of the CCHX configurations that include one or more of the CCHX conduits, as described with respect to FIGS. 8-65 and 67. The method 6600 is an omnigravity, multi-phase separation method, meaning that the CCHX conduit and/or CCHX may separate liquid from the humid airstream independent of the force of gravity.

At 6602, the method 6600 includes directing an airstream into a CCHX conduit via an inlet, where the CCHX conduit has a chamber with a tapered teardrop profile and cusp-like structure formed of a repeating pattern of elliptical ribs oriented at a bias angle with respect to a first plane. The airstream may contain one or more of liquid droplets, humid air, or gas with a condensable vapor (e.g., a liquid gas mixture, such as water and air). As described above, the CCHX may include one or more conduits, where the conduit(s) comprise(s) a chamber configured to direct flow of an airstream containing one or more of liquid droplets, humid air, or gas with a condensable vapor from the inlet to the gas outlet and direct liquid droplets out of the airstream and to the liquid outlet.

At 6604, the method 6600 includes condensing liquid from the airstream into droplets. Condensing liquid from the airstream includes passively preferentially locating liquid for recirculation by wicking wall-bound liquid drops, via passive capillary forces, from poorly wetted regions to more favorably wetted regions in a manner that maintains a predominately dropwise condensation process.

At 6606, the method 6600 includes directing droplets that are increasing in volume into gaps between each of the elliptical ribs of the cusp-like structure of the conduit. For example, when a size of a liquid droplet is greater than a width of an elliptical rib of the cusp-like structure of the CCHX conduit, the liquid droplet spans and enters a cusp region (e.g., gap) of the cusp-like structure of interior walls of the CCHX conduit.

At 6608, the method 6600 includes wicking droplets towards a vertex of the teardrop profile. For example, droplets are wicked along the cusp region in both directions, eventually making capillary connection with the vertex of the conduit.

At 6610, the method 6600 includes directing liquid out of the CCHX conduit via a liquid outlet. For example, the liquid outlet of the CCHX conduit may be coupled to a liquid drain.

At 6612, the method 6600 includes directing gas of the airstream out of the CCHX conduit via a gas outlet. The inlet of the CCHX may be in the same plane as, and axially offset from, the gas outlet. The inlet and the gas outlet may be positioned on the same axis (e.g., the first axis).

A rate of condensation of liquid droplets from the airstream may be increased by cooling the airstream. The method 6600 may optionally include one or more steps to cool the CCHX to increase the rate of condensation. For example, the method 6600 may include directing a cooling liquid through a coolant system that is adjacent to and fluidically separate from the conduit(s). In another example, the method 6600 may additionally or alternatively include using a fan to blow air over an external surface of the CCHX.

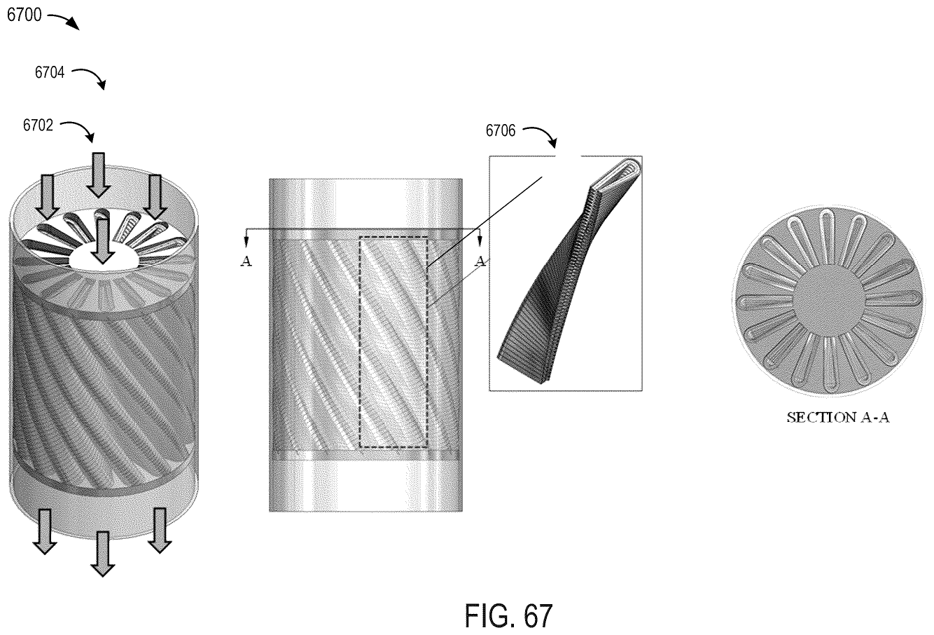

FIG. 67 shows views 6700 of an example spiral CCHX 6702 that includes the CCHX conduit 102 positioned in a helical or spiral configuration. The spiral CCHX 6702 is shown as a cylinder CCHX, similar to the hollow cylinder CCHX 2202, the CCC CCHX 2902, the CFC CCHX 4702, and/or the CHC CCHX 3702, as an example. The helical and/or spiral nature of the spiral CCHX conduit 6702 described with respect to FIG. 67 may be implemented in other CCHX configurations without departing from the scope of the present disclosure. The helical and/or spiral nature of the CCHX conduit 102 may be capable of coalescing free droplets via wall impacts and/or centrifugal force-driven wall impacts (e.g., with internal walls of the chamber 402 of the CCHX conduit 102). A first view 6704 includes arrows indicating a direction of input and output to the spiral CCHX 6702 While in the CCHX conduit 102, the airflow is directed along the helical and/or spiral nature of the CCHX conduit 102; there may not be a straight through path for the free drops to pass from the first end 104 to the second end 106. A detailed view 6706 of a single CCHX conduit 102 of a set of CCHX conduits of the spiral CCHX 6702 is shown, illustrating the helical and/or spiral nature of each CCHX conduit 102.

In this way, the CCHX conduit described herein provides high performance dropwise condensation throughout a majority of the channels, capillary conduit geometry passively guides condensate naturally to condensate exit ports, critically geometrically wetted substrates provide effective superhydrophilic wetting with three-dimensional (3D) crosstalk across the device, passive bubble phase separation, reduced carry-over due to efficient pinning that further increases stability to physical perturbations, decreased time of device drying post-use, and increased options for coating-free material selection and fabrication to address concerns of long-term contamination.

FIGS. 1-64 and 67 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A capillary condensing heat exchanger (CCHX) conduit, comprising:
an inlet at a first end;
a gas outlet at a second end, opposite the first end;
a liquid outlet at the second end; and
a chamber configured to direct flow of an airstream containing one or more of liquid droplets, humid air, or gas with a condensable vapor from the inlet to the gas outlet and direct liquid droplets out of the airstream and to the liquid outlet, wherein the chamber has a teardrop profile, the chamber further having interior walls with a cusp-like structure oriented at a bias angle with respect to a first plane.

2. The CCHX conduit of claim 1, wherein the cusp-like structure comprises a repeating pattern of elliptical ribs defined by a width of each elliptical rib, a gap width of a gap between elliptical ribs, and a height of each elliptical rib that extend towards a central axis of the chamber.

3. The CCHX conduit of claim 2, wherein each elliptical rib of the cusp-like structure extends continuously around a first side, a third side, and a fourth side of an internal perimeter of interior walls of the chamber.

4. The CCHX conduit of claim 1, wherein a vertex of the teardrop profile of the chamber is axially aligned with the liquid outlet along a second axis.

5. The CCHX conduit of claim 1, wherein an apex of the teardrop profile of the chamber is axially aligned with the gas outlet along a first axis.

6. The CCHX conduit of claim 1, further comprising a coolant system positioned external to and fluidly isolated from the chamber, where the coolant system comprises a coolant channel that extends parallel to the chamber.

7. The CCHX conduit of claim 6, wherein the coolant channel has a serpentine pattern.

8. The CCHX conduit of claim 6, wherein the coolant channel extends from a first side of the CCHX conduit, superior to an apex of the teardrop profile of the chamber, and to a second side of the CCHX conduit, opposite the first side.

9. A capillary condensing heat exchanger (CCHX), comprising:
a set of CCHX conduits, wherein each CCHX conduit of the set of CCHX conduits comprises an inlet at a first end, a gas outlet and a liquid outlet at a second end, and a chamber having a teardrop profile and interior walls with a cusp-like structure oriented at a bias angle with respect to a first plane that are configured to direct flow of an airstream containing one or more of liquid droplets, humid air, or gas with a condensable vapor from the inlet to the gas outlet and direct liquid droplets out of the airstream and to the liquid outlet;
a liquid outlet channel that is coupled to each CCHX conduit of the set of CCHX conduits via the liquid outlet of a respective CCHX conduit, the liquid outlet channel further having a liquid outlet port; and
a coolant system configured to cool the set of CCHX conduits that is positioned external to and fluidly isolated from chambers of the set of CCHX conduits, the coolant system comprising a coolant inlet on a first channel positioned near the first end of the CCHX, a coolant outlet on a second channel positioned near the second end of the CCHX, and a set of coolant channels that are fluidly coupled to the first channel and the second channel.

10. The CCHX of claim 9, wherein:
each CCHX conduit of the set of CCHX conduits is stacked vertically with respect to other CCHX conduits of the set of CCHX conduits such that a vertex of the teardrop profile of a first CCHX conduit is arranged superior to an apex of the teardrop profile of a second CCHX conduit, and the vertex of the teardrop profile of the second CCHX conduit is arranged superior to the apex of the teardrop profile of a third CCHX conduit;
the inlet of each CCHX conduit of the set of CCHX conduits are vertically aligned;
the gas outlet of each CCHX conduit of the set of CCHX conduits are vertically aligned; and
the liquid outlet of each CCHX conduit of the set of CCHX conduits are vertically aligned.

11. The CCHX of claim 9, wherein the coolant system is positioned parallel to the set of CCHX conduits, such that:
the first channel extends a height of the CCHX;
the second channel is positioned posterior to the first channel and extends the height of the CCHX; and
each coolant channel of the set of coolant channels has a serpentine pattern and extends from a first side of a respective CCHX conduit of the set of CCHX conduits, superior to an apex of a respective chamber, and to a second side of the respective CCHX conduit, opposite the first side.

12. The CCHX of claim 9, wherein:
each CCHX conduit of the set of CCHX conduits is stacked horizontally with respect to other CCHX conduits of the set of CCHX conduits such that a vertex of the teardrop profile of each CCHX conduit of the set of CCHX conduits are aligned along a third axis;
the inlet of each CCHX conduit of the set of CCHX conduits are horizontally aligned;
the gas outlet of each conduit of the set of conduits are arranged at the bias angle with respect to the first plane; and
the liquid outlet of each CCHX conduit of the set of CCHX conduits are horizontally aligned.

13. The CCHX of claim 9, wherein the coolant system is positioned superior to the set of CCHX conduits, such that:
the first channel extends a width of the CCHX;
the second channel extends the width of the CCHX, parallel to the first channel; and
each coolant channel of the set of coolant channels has a serpentine pattern and extends from a first side of a respective CCHX conduit of the set of CCHX conduits, superior to an apex of a respective chamber, and to a second side of the respective CCHX conduit, opposite the first side.

14. The CCHX of claim 9, wherein:
each CCHX conduit of the set of CCHX conduits is arranged circumferentially about a central axis of the CCHX such that a vertex of the teardrop profile of each CCHX conduit of the set of CCHX conduits is proximal to the central axis and an apex of the teardrop profile of each CCHX conduit of the set of CCHX conduits is distal to the central axis;
the inlet of each conduit of the set of conduits are arranged in the first plane;
the gas outlet of each conduit of the set of conduits are arranged at the bias angle with respect to the first plane; and
the liquid outlet of each conduit of the set of conduits are arranged parallel to the inlet.

15. The CCHX of claim 14, further comprising a cusped shaft that extends along the central axis of the CCHX, the cusped shaft comprising a cusp-like structure that extends radially from the cusped shaft towards the set of CCHX conduits and are oriented parallel to the central axis, where the cusped shaft is configured to direct flow of the airstream containing one or more of liquid droplets, humid air, or gas with the condensable vapor from cusp-like structure of the set of CCHX conduits to the liquid outlet channel.

16. The CCHX of claim 15, wherein the vertex of the teardrop profile of each CCHX conduit is open to the central axis of the CCHX, such that each CCHX conduit of the set of CCHX conduits is in fluidic communication with the cusp-like structure of the cusped shaft.

17. The CCHX of claim 14, further comprising a central drain that is axially aligned with the central axis of the CCHX and where each CCHX conduit of the set of CCHX conduits is fluidly coupled to the central drain by a vane that extends from a median between of each CCHX conduit of the set of CCHX conduits to the central drain.

18. The CCHX of claim 14, further comprising a circumferential coolant channel that extends circumferentially within a hollow center of the CCHX and is fluidly coupled to the first channel and the second channel of the coolant system.

19. The CCHX of claim 9, wherein the coolant system circumferentially surrounds the set of CCHX conduits, such that:
the first channel circumferentially surrounds a body of the CCHX;
the second channel circumferentially surrounds the body of the CCHX; and
each coolant channel of the set of coolant channels has a serpentine pattern and extends from a first side of a respective CCHX conduit of the set of CCHX conduits, superior to an apex of a respective chamber, and to a second side of the respective CCHX conduit, opposite the first side.

20. A method for omnigravity multi-phase separation, comprising:
directing a humid airstream into a capillary condensing heat exchanger (CCHX) conduit via an inlet, where the CCHX conduit has a chamber with a teardrop profile and cusp-like structure formed of a repeating pattern of elliptical ribs oriented at a bias angle with respect to a first plane;
condensing liquid from the humid airstream into droplets;
directing droplets that are increasing in volume into gaps between each of the elliptical ribs of the cusp-like structure of the conduit;
wicking droplets towards a vertex of the teardrop profile;
directing liquid out of the CCHX conduit via a liquid outlet; and
directing gas of the humid airstream out of the CCHX conduit via a gas outlet.
